(19) United States
(12) Patent Application Publication
(10) Pub. No.: US 2006/0223002 A1
(43) Pub. Date: Oct. 5, 2006

(54) Planographic printing plate precursor having an image-recording layer containing an infrared ray absorbent, a polymerization initiator, a polymerizable compound, and a thiol compound

(75) Inventor: Hiromitsu Yanaka, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/391,438

(22) Filed: Mar. 29, 2006

(30) Foreign Application Priority Data
Mar. 29, 2005 (JP) 2005-95720
Sep. 27, 2005 (JP) 2005-280818

(51) Int. Cl. G03C 1/00

(52) U.S. Cl. 430/270.1

(57) ABSTRACT

The present invention provides a planographic printing plate precursor having a support and, on the support, an image-recording layer containing an infrared ray absorbent, a polymerization initiator, a polymerizable compound, and a thiol compound. The planographic printing plate precursor preferably has a protective layer on the image-recording layer.

### CROSS-REFERENCE TO RELATED APPLICATION

This application claims priority under 35 USC 119 from Japanese Patent Application Nos. 2005-095720 and 2005-280818, the disclosures of which are incorporated by reference herein.

### BACKGROUND OF THE INVENTION

1. Field of the Invention

The present invention relates to a negative-type planographic printing plate precursor that allows direct drawing with an infrared laser beam and high-speed processing, and in particular, to a negative-type planographic printing plate precursor having improved properties of resistance to the adhesion between the image-recording layer-side surface of the planographic printing plate precursor and the support-side surface of the adjacent planographic printing plate precursor when stacked.

2. Description of the Related Art

Conventionally, PS plates having an oleophilic photosensitive resin layer formed on a hydrophilic support have been widely used as planographic printing plate precursors, and printing plates have commonly been produced by exposing the surface thereof to light through a lith film serving as a mask (mask exposure or area exposure), and then dissolving and removing the non-image regions. In recent years, digitalized technologies, in which image information is processed, stored, and output electronically by a computer, are becoming widespread. Accordingly, a variety of new image-output methods compatible with these types of digitalized technologies have been commercialized. As a result, there is an urgent need for a computer-to-plate (CTP) technology that allows direct production of printing plates by scanning printing plate precursors with highly directional light, such as laser beams, according to digitalized image information without the use of a lith film, and achieving a planographic printing plate precursor that is compatible with such a CTP technology.

As a planographic printing plate precursor compatible with such scanning and light exposure, a planographic printing plate precursor which has an oleophilic photosensitive resin layer (hereinafter, referred to as an “image-recording layer”) containing a photosensitive compound that can generate an active species such as a free radical or a Bronsted acid by laser-light exposure on a hydrophilic support has already been proposed and commercialized. The planographic printing plate precursor is scanned with a laser according to digital information so as to generate the active species, which causes physical or chemical change in the image-recording layer to insolubilize the exposed regions, and subsequently the non-exposed regions are developed to obtain a negative-type planographic printing plate. In particular, a planographic printing plate precursor which has a photopolymerizable photosensitive layer containing a photopolymerization initiator superior in photosensitization speed, an addition-polymerizable ethylenically unsaturated compound, and a binder polymer soluble in an alkaline developing solution, and optionally, an oxygen-blocking protective layer on a hydrophilic support is possibly a desirable printing plate having superior printing properties because it has high productivity, easy developability, and superior resolution and inking properties. Heretofore, in order to accelerate the reaction to harden the image-recording layer, formation of a protective layer containing a water-soluble polymer or a protective layer containing a lamellar inorganic compound and a water-soluble polymer on an image-recording layer have been known (e.g., Japanese Patent Application Laid-Open (JP-A) No. 11-38633). Photopolymerizable planographic printing plate precursors having such configurations indeed can accelerate the reaction to harden the image recording layer due to the presence of the protective layer, but have unsatisfactory sensitivity, and still have demanded further improvement in sensitivity.

On the other hand, a reduction in the time needed in the light-exposure step is important for improving productivity in making a photopolymerizable planographic printing plate precursor providing simple and quick development treatment into a printing plate. Usually, the planographic printing plate precursors are supplied to the light exposure step as a stacked body containing between the precursors an insert paper for preventing adhesion of the plate precursors. As a result, the time needed for removing the insert paper results in inefficiency in the light-exposure step. In order to improve efficiency in the light-exposure step, it is desirable to eliminate the step of removing the insert paper by using a stacked body containing no insert paper between the precursors. Thus, there exists a demand for improvement in the resistance to adhesion between planographic printing plate precursors.

For that reason, there exists a need for a high-sensitivity and high-printing durability planographic printing plate precursor that allows direct writing with an infrared laser.

In addition, there exists a need for a planographic printing plate precursor allowing direct writing with an infrared laser, and having high sensitivity, high printing durability, improved efficiency in making the photopolymerizable planographic printing plate precursor into a printing plate, and, even if the planographic plate precursors are stacked without an insert paper therebetween, improved resistance to the adhesion between the image-recording layer-side surface of the planographic printing plate precursor and the support-side surface of the adjacent planographic printing plate precursor.

### SUMMARY OF THE INVENTION

After intensive studies to satisfy the needs, the inventor has found that inclusion of a thiol compound in an image-recording layer enables attainment of a high-sensitivity, high-printing durability planographic printing plate precursor.

The invention provides a planographic printing plate precursor having a support and, on the support, an image-recording layer containing an infrared ray absorbent, a polymerization initiator, and a polymerizable compound, and a thiol compound.

The planographic printing plate precursor allows direct writing with an infrared laser and has high sensitivity and high printing durability.

### BRIEF DESCRIPTION OF THE DRAWINGS

FIG. 1 is a view schematically illustrating the configuration of an example of a DRM interference wave-measuring instrument used for obtaining the dissolution behavior of an image-recording layer.

FIG. 2 is a view schematically illustrating the configuration of an example of a method for measuring electrostatic capacity used for evaluating the penetrating property of a developing solution into an image-recording layer.

### DETAILED DESCRIPTION OF THE INVENTION

Hereinafter, the planographic printing plate precursor of the invention will be described in detail.

The planographic printing plate precursor of the invention has a support and, on the support, an image-recording layer containing an infrared-lay absorbent, a polymerization initiator, a polymerizable compound, and a thiol compound.

The planographic printing late precursor preferably has a protective layer on the image-recording layer. In this case, when the protective layer contains a lamellar inorganic compound, the planographic printing plate precursor has improved efficiency in making the photopolymerizable planographic printing plate precursor into a printing plate, and, even if the planographic plate precursors are stacked without an insert paper therebetween, improved resistance to the adhesion between the image-recording layer-side surface of the planographic printing plate precursor and the support-side surface of the adjacent planographic printing plate precursor, as well as allowing direct writing with an infrared laser, and having high sensitivity and high printing durability.

The planographic printing plate precursor of the invention may also have other layers, such as intermediate layer or a back-coat layer according to intended application.

Each structural element of the planographic printing plate precursor of the invention will be described below.

Image-Recording Layer

The image-recording layer in the invention is a negative-type polymerizable image-recording layer containing an infrared ray absorbent, a polymerization initiator, a polymerizable compound, and a thiol compound as essential components, and optionally, a binder, a colorant, and other components.

The negative-type polymerizable image-recording layer in the invention is sensitive to infrared light, and thus to an infrared laser, which is useful for CTP printing plate making. The infrared ray absorbent contained therein undergoes infrared laser irradiation (exposure) at high sensitivity and is excited to an electronically excited state. The electron transfer, energy transfer, and heat generation (light-heat conversion function) caused by the electronically excitation act on the polymerization initiator present in the image-recording layer. Thereby, the polymerization initiator chemically changes to generate radicals.

Examples of a mechanism for generating radicals include the following: (1) heat generated by the light-heat conversion function of the infrared ray absorbent causes the polymerization initiator described later (for example, a sulfonium salt) to thermally decompose, which generates radicals; (2) excited electrons generated by the infrared ray absorbent migrate to a polymerization initiator (for example, an active halogen compound), generating radicals; and (3) electrons migrate from a polymerization initiator (for example, a borate compound) to the excited infrared ray absorbent, generating radicals. The generated radicals initiate polymerization reaction of the polymerizable compound, and the exposed regions harden into image regions.

The planographic printing plate precursor of the invention which contains an infrared ray absorbent in the image-recording layer is particularly favorable for printing plate making using direct drawing with an infrared laser beam having a wavelength of 750 to 1400 nm, and has an image-forming property higher than those of conventional planographic printing plate precursors. Hereinafter, the components of the image-recording layer in the invention will be described.

Thiol Compound

The image-recording layer in the invention contains a thiol compound, as described above. In the invention, presence of the thiol compound in the aforementioned negative-type polymerizable image-recording layer is effective in providing a planographic printing plate precursor with high sensitivity and high printing durability.

The thiol compound in the invention, which is preferably a compound represented by the following Formula (I), is used as a chain transfer agent, allows efficient use of the generated radicals (active species) and accelerates polymerization reaction. It is thought that use of the thiol compound in the invention can prevent deterioration of sensitivity due to vaporization of the thiol compound from the image-recording layer or diffusion of the thiol compound into other layers, and, therefore, can provide a planographic printing plate precursor with high sensitivity and high printing durability. Use of the thiol compound can also reduce odor.

The thiol compound in the invention is, for example, an organic compound containing at least one SH group, and more preferably a hydrocarbon compound containing at least one SH group. The compound may have only one —SH group or multiple —SH groups in the molecule.

When the thiol compound is a chain compound, it can be an aliphatic hydrocarbon containing at least one SH group on the side chain(s) or terminal(s) thereof. Such a hydrocarbon compound may be linear or branched, and may further have any other substituent(s) such as a hydroxyl group, a halogen atom, or an amino group. The methylene group in the hydrocarbon compound may have, as at least one substituent, at least one bivalent organic group of such a compound as ether, thioether, ester, amide, urea, or thiourea.

Examples of such a hydrocarbon compound include those obtained by introducing at least one —SH group to either or both of the terminals of each of linear hydrocarbons having about 2 to about 18 carbon atoms such as an ethane, butane, hexane, nonane, decane, dodecane, and octadecane, those obtained by introducing at least one —SH group to the chain of each of the linear hydrocarbons having about 2 to about 18 carbon atoms, and those obtained by substituting at least one of the methine group(s) in the hydrocarbon chain of each of the linear hydrocarbons with an ether or ester bond.

When the thiol compound is a cyclic compound, it can be alicyclic hydrocarbon, aromatic hydrocarbon, fused polycyclic hydrocarbon, or a heterocyclic compound. Alternatively, the thiol compound may have two or more mutually independent ring structures in the molecule. In addition to the —SH group, the cyclic hydrocarbon compound may also have any other substituent such as an alkyl group, a halogen atom, or a hydroxyl group in the ring structure thereof.

Examples of such a cyclic hydrocarbon compound include those obtained by substituting at least one of the hydrogen atoms of such cyclic hydrocarbon compounds as cyclohexane, benzene, and naphthalene with at least one —SH groups; cyclic hydrocarbon compounds having at least one substituent, such as an alkyl group, which contains at least one —SH group; heterocyclic compounds having at least one —SH group.

As described above, the thiol compound in the invention is preferably a compound represented by the following Formula (I).

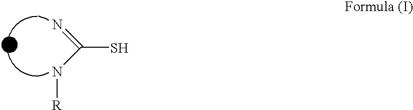

In Formula (I), R represents an alkyl group that may have at least one substituent or an aryl group that may have at least one substituent. A represents an atomic group which, together with the N═C—N portion, forms a five- or six-membered carbon atom-containing heterocyclic ring, and may have at least one substituent.

In Formula (I), examples of the alkyl group represented by R include those having 1 to 12 carbon atoms and cycloalkyl groups. These alkyl and cycloalkyl groups may have at least one substituent. Examples of the substituent(s) that the alkyl group may have include hydrocarbon groups having 20 or less carbon atoms, halogen atoms, a cyano group, a carboxyl group, sulfonyl groups, sulfinyl groups, alkoxyoxy groups, and amino groups.

In Formula (I), the aryl group represented by R is, for example, an aromatic hydrocarbon group that may have at least one substituen. The aromatic hydrocarbon group is preferably a benzene or naphthalene ring. Typical examples of the substituent(s) that the aryl group may have include hydrocarbon groups having 20 or less carbon atoms, halogen atoms, a cyano group, a carboxyl group, sulfonyl groups, sulfinyl groups, alkoxyoxy groups, and amino groups.

In Formula (I), examples of the five- or six-membered carbon atom-containing heterocyclic ring which A and the N═C—N portion forms include imidazole, triazole, benzimidazole, benzothiadiazole, pyrimidine, and imidazoline rings. The five- or six-membered carbon atom-containing heterocyclic ring is preferably a triazole or benzimidazole ring.

Examples of the substituent(s) that A may have include hydrocarbon groups having 20 or less carbon atoms, halogen atoms, a cyano group, a carboxyl group, sulfonyl groups, sulfinyl groups, alkoxyoxy groups, and amino groups.

The thiol compound represented by Formula (I) is preferably a thiol compound represented by the following Formula (II) or (III).

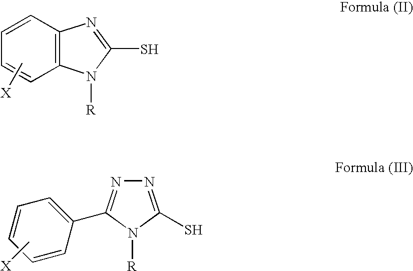

In Formula (II) or (III), R represents an alkyl group that may have at least one substituent or an aryl group that may have at least one substituent. X represents a halogen atom, an alkoxyl group, an alkyl group that may have at least one substituent, or an aryl group that may have at least one substituent.

In Formula (II) or (III), the alkyl group represented by R has the same meaning as in Formula (I), and the typical examples thereof are also the same.

In Formula (II) or (III), the aryl group represented by R has the same meaning as in Formula (I), and the typical examples thereof are also the same.

In Formula (II) or (III), the halogen atom represented by X is, for example, a fluorine, chlorine, or iodine atom.

In Formula (II) or (III), the alkoxyl group represented by X preferably has 20 or less carbon atoms.

In Formula (II) or (III), the alkyl group represented by X preferably has 20 or less carbon atoms.

In Formula (II) or (III), the aryl group represented by X is, for example, an aromatic hydrocarbon group that may have at least one substituent. The aromatic hydrocarbon group is preferably a benzene or naphthalene ring. Typical examples of the substituent(s) that the aryl group may have include hydrocarbon groups having 20 or less carbon atoms, halogen atoms, a cyano group, a carboxyl group, sulfonyl groups, sulfinyl groups, alkoxyoxy groups, and amino groups.

Hereinafter, typical examples of the compound represented by Formula (I) will be shown, however the invention is not limited by these examples.

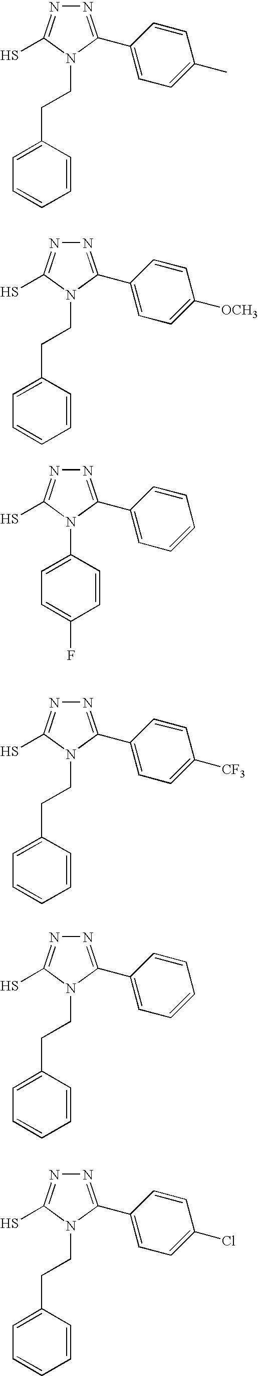

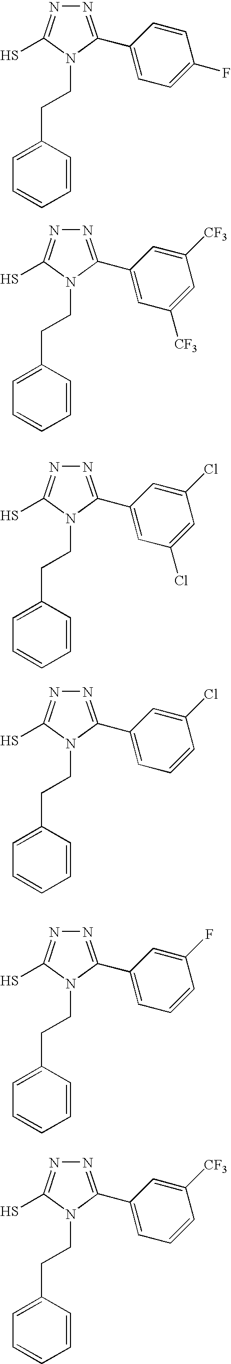

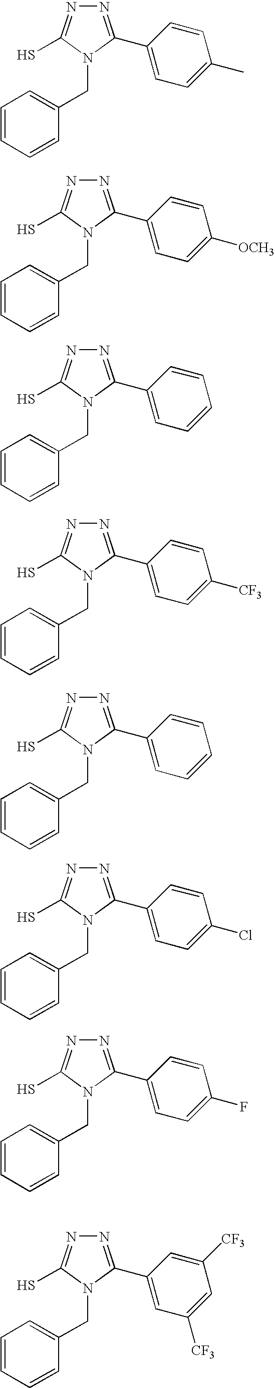

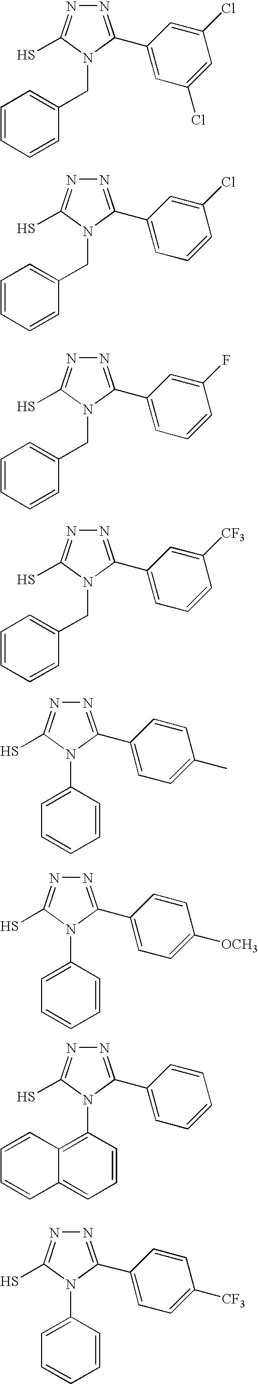

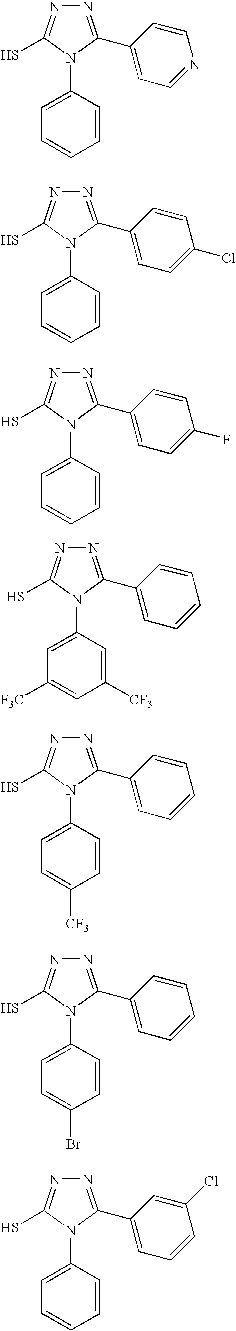

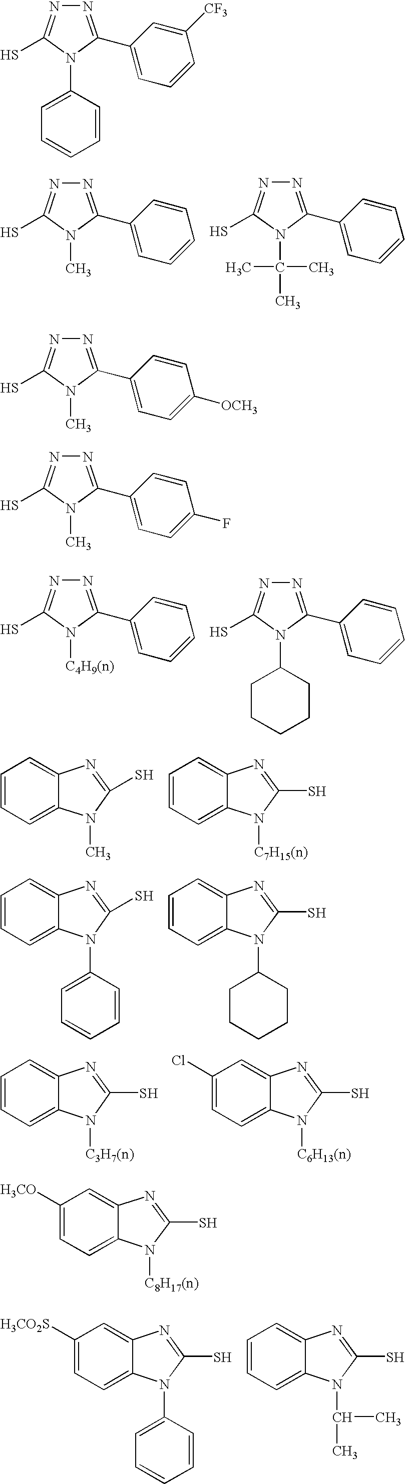

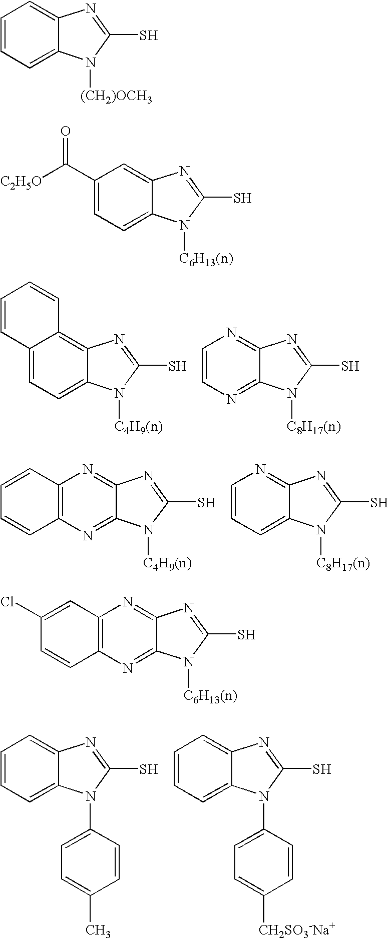

The content of the thiol compound in the invention is preferably 0.01 to 20% by mass, more preferably 0.1 to 15% by mass, and still more preferably 1.0 to 10% by mass with respect to the total mass of the solid matters in the image-recording layer.

One thiol compound may be used alone or two or more thiol compounds can be used together.

Infrared Ray Absorbent

The image-recording layer in the invention contains an infrared ray absorbent to obtain an energy transfer (electron transfer) function and/or a light-heat conversion function.

The infrared ray absorbent undergoes infrared laser irradiation (exposure) at high sensitivity and is excited to an electronically excited state. The electron transfer, energy transfer, and heat generation (light-heat conversion function) caused by the electronically excitation act on a polymerization initiator described later. The infrared ray absorbent is, therefore, effective in chemically changing the polymerization initiator at high sensitivity to generate radicals.

The infrared ray absorbent for use in the invention is preferably a dye or pigment having an absorption maximum in the wavelength range of 750 to 1400 nm.

Such a dye can be at least one of commercially available dyes and known dyes disclosed in “Dye Handbook” edited by The Society of Synthetic Organic Chemistry, Japan and published in 1970. Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalelium dyes, pyrylium salts, and metal thiolate complexes.

The dye is preferably at least one of cyanine dyes disclosed in JP-A Nos. 58-125246, 59-84356, and 60-78787, methine dyes disclosed in JP-A Nos. 58-173696, 58-181690, and 58-194595, naphthoquinone dyes disclosed in Nos. 58-112793, 58-224793, 59-48187, 59-73996, 60-52940, and 60-63744, squalelium dyes disclosed in JP-A No. 58-112792, and cyanine dyes disclosed in U. K. Patent No. 434,875.

At least one of near infrared ray absorption sensitizers disclosed in U.S. Pat. No. 5,156,938, substituted arylbenzo(thio)pyrylium salts disclosed in U.S. Pat. No. 3,881,924, trimethine thiapyrylium salts disclosed in JP-A No. 57-142645 (U.S. Pat. No. 4,327,169), pyrylium compounds disclosed in JP-A Nos. 58-181051, 58-220143, 59-41363, 59-84248, 59-84249, 59-146063, and 59-146061, cyanine dyes disclosed in JP-A No. 59-216146, pentamethine thiopyrylium salts disclosed in U.S. Pat. No. 4,283,475, and pyrylium salts disclosed in JP-B Nos. 5-13514 and 5-19702 is preferably used as the dye. The dye is also preferably at least one of near infrared ray absorption dyes represented by Formulae (I) and (II) of U.S. Pat. No. 4,756,993.

Moreover, the infrared ray absorbing dye in the invention is also preferably at least one of specific indolenine cyanine dyes disclosed in Japanese Patent Application Nos. 2001-6326, and 2001-237840 and shown below.

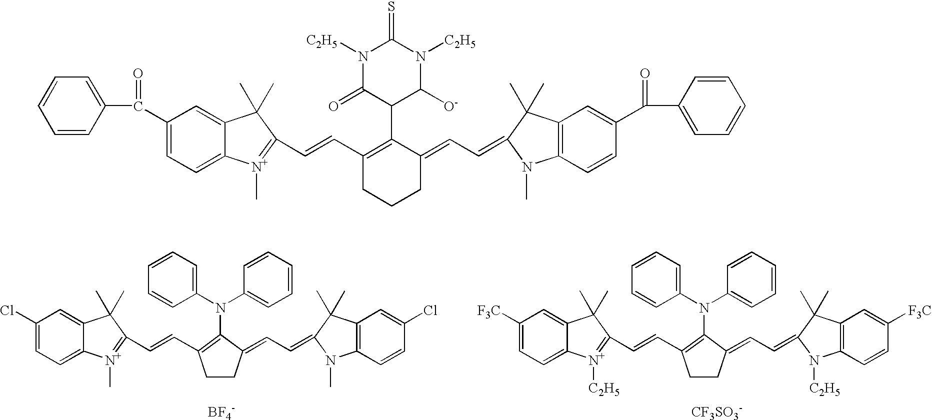

The infrared ray absorbent in the invention is more preferably at least one of cyanine dyes, squalelium dyes, pyrylium salts, nickel thiolate complexes, and indolenine cyanine dyes, still more preferably at least one of cyanine dyes and indolenine cyanine dyes, and still more preferably at least one of cyanine dyes represented by the following Formula (a).

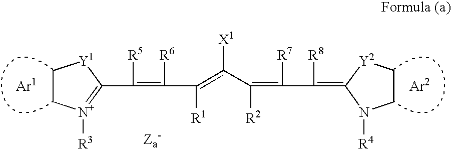

In Formula (a), X¹ represents a hydrogen atom, a halogen atom, —NPh₂, X²-L¹, or a group shown below. Here, X² represents an oxygen atom, a nitrogen atom, or a sulfur atom, and L¹ represents a hydrocarbon group having 1 to 12 carbon atoms, an aromatic ring having at least one hetero atom, or a hydrocarbon group containing at least one hetero atom and having 1 to 12 carbon atoms. The hetero atom is N, S, O, a halogen atom, or Se. Definition of Xₐ⁻ is the same as that of Zₐ⁻ described later, and R^{a} represents a hydrogen atom or a substituent selected from alkyl groups, aryl groups, substituted or unsubstituted amino groups, and halogen atoms.

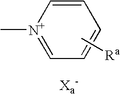

R¹ and R² independently represent a hydrocarbon group having 1 to 12 carbon atoms. Each of R¹ and R² is preferably a hydrocarbon group having two or more carbon atoms from the viewpoint of storage stability of an image-recording layer coating liquid. R¹ and R² preferably bind to each other to form a five- or six-membered ring.

Ar¹ and Ar² may be the same or different, and represent an aromatic hydrocarbon group which may have at least one substituent. Typical examples of the aromatic hydrocarbon group include a benzene ring and a naphthalene ring. Also, typical examples of the substituent(s) include hydrocarbon groups having 12 or less carbon atoms, halogen atoms and alkoxy groups having 12 or less carbon atoms. Y¹ and Y² may be the same or different, and represent a sulfur atom or a dialkylmethylene group having 12 or less carbon atoms. R³ and R⁴ may be the same or different, and represent a hydrocarbon group which may have at least one substituent and which has 20 or less carbon atoms. Typical examples of the substituent(s) include alkoxy groups having 12 or less carbon atoms, a carboxyl group and a sulfo group. R⁵, R⁶, R⁷ and R⁸ may be the same or different, and represent a hydrogen atom or a hydrocarbon group having 12 or less carbon atoms. In light of availability of raw materials, they are preferably hydrogen atoms. Za⁻ represents a counter anion. However, Za⁻ is not necessary, if the cyanine pigment represented by Formula (a) has an anionic substituent in the structure thereof, and, therefore, does not need neutralization of charge due to a counter anion. Za⁻ is preferably a halogen ion, a perchlorate ion, a tetrafluoroborate ion, a hexafluorophosphate ion or a sulfonate ion in view of storability of an image-recording layer coating liquid, Za⁻ is more preferably a perchlorate ion, a hexafluorophosphateate ion or an arylsulfonate ion.

Typical examples of the cyanine dye represented by Formula (I) used in the invention include those described in paragraph Nos. [0017] to [0019] of JP-A No. 2001-133969.

Alternatively, the cyanine dye is preferably at least one of specific Indolenine cyanine dyes described in Japanese Patent Application Nos. 2001-6326 and 2001-237840.

It is preferable that the counter ion includes no halogen ion.

The pigment used in the invention may be at least one of commercially available pigments and pigments described in Color Index (C.I.) Handbook, “Latest Pigment Handbook” (edited by Japan Pigment Technique Association, and published in 1977), “Latest Pigment Applied Technique” (published by CMC Publishing Co., Ltd. in 1986), and “Printing Ink Technique” (published by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, at least one of insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black can be used as the pigment. The pigment is preferably carbon black.

These pigments may or may not be surface-treated. Examples of the surface treatment include a method of coating the surface of a pigment with a resin or wax; a method of adhering a surfactant onto the surface of a pigment, and a method of bonding a reactive material, such as a silane coupling agent, an epoxy compound, or a polyisocyanate, to the surface of a pigment. The surface treatment methods are described in “Nature and Application of Metal Soap” (Saiwai Shobo), “Printing Ink technique” (published by CMC Publishing Co., Ltd. in 1984), and “Latest Pigment Applied Technique” (published by CMC Publishing Co., Ltd. in 1986).

The average diameter of the pigment particles is preferably in the range of 0.01 to 10 μm, more preferably in the range of 0.05 to 1 μm and still more preferably in the range of 0.1 to 1 μm. The pigment particles having an average diameter within the above range are stably dispersed in the image-recording layer and thus enable formation of a uniform image-recording layer.

The method for dispersing the pigment in a solvent may be a known dispersing technique used to produce an ink or a toner. Examples of the dispersing machine used in the method include an ultrasonic disperser, a sand mill, an attritor, a pearl mill, a super mill, a ball mill, an impeller, a dispersers, a KD mill, a colloid mill, a dynatron, a three-roll mill, and a pressing kneader. Details thereof are described in “Latest Pigment Applied Technique” (published by CMC Publishing Co., Ltd. in 1986).

Although the infrared ray absorbent is contained in the image-recording layer, the infrared ray absorbent and the other essential components may be included in the same layer or different layers.

From the viewpoints of uniformity and durability of the image-recording layer, the content of the infrared ray absorbent in the image-recording layer is generally 0.01 to 50% by mass, preferably 0.1 to 10% by mass, and, in the case of a dye, more preferably 0.5 to 10% by mass or, in the case of a pigment, more preferably 0.1 to 10% by mass relative to the total solid content of the image-recording layer.

Polymerization Initiator

The polymerization initiator used in the invention may be any of compounds which have a function of initiating and advancing curing reaction of a polymerizable compound described later and can generate radicals due to application of energy thereto. Such a compound can be a thermal decomposition-type radical generator that, when heated, decomposes to generate radicals, an electron transfer-type radical generator that receives an excited electron from the infrared ray absorbent to generate radicals, and/or an electron transfer-type radical generator that generate electrons, which move to the excited infrared ray absorbent so as to generate radicals. Specific examples thereof include onium salts, activated halogen compounds, oxime ester compounds, and borate compounds. Two or more of these initiators may be used together. In the invention, the polymerization initiator is preferably an onium salt, and more preferably a sulfonium salt.

The sulfonium salt polymerization initiator preferably used in the invention can be an onium salt represented by the following Formula (I).

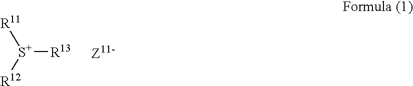

In Formula (I), R¹¹, R¹² and R¹³ may be the same or different, and independently represent a hydrocarbon group having 20 or less carbon atoms which may have at least one substituent. Typical examples of the substituent include halogen atoms, a nitro group, alkyl groups having 12 or less carbon atoms, alkoxy groups having 12 or less carbon atoms, and aryloxy groups having 12 or less carbon atoms. Z¹¹⁻ represents a counter ion selected from the group consisting of a halogen ion, a perchlorate ion, a tetrafluoroborate ion, a hexafluorophosphate ion, a carboxylate ion, and a sulfonate ion. Z¹¹⁻ is preferably a perchlorate ion, a hexafluorophosphate ion, a carboxylate ion, or an arylsulfonate ion. Z¹¹⁻ may have at least one substituent, if possible.

Hereinafter, typical examples of the onium salt represented by Formula (I) ([OS-1] to [OS-12]) are shown below, but the invention is not limited by these compounds.

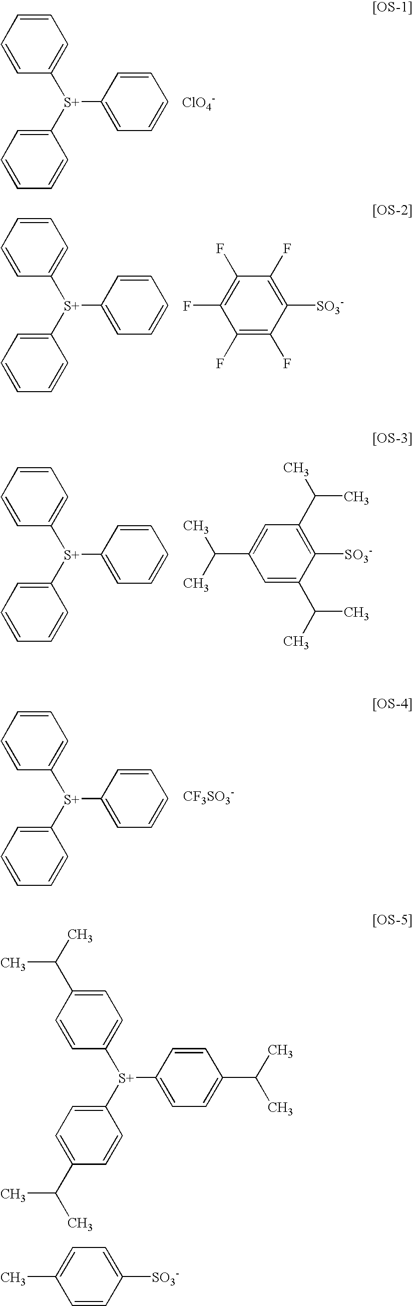

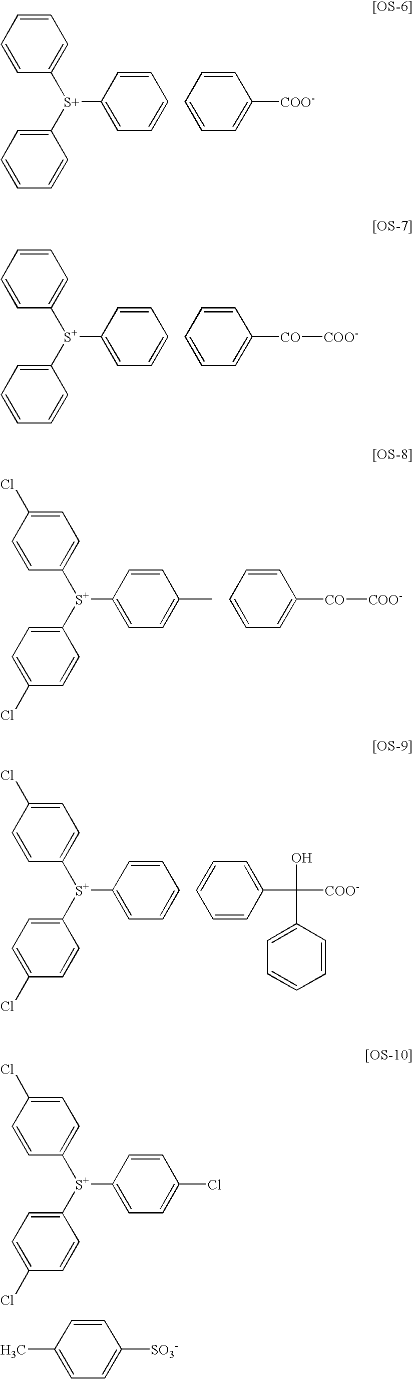

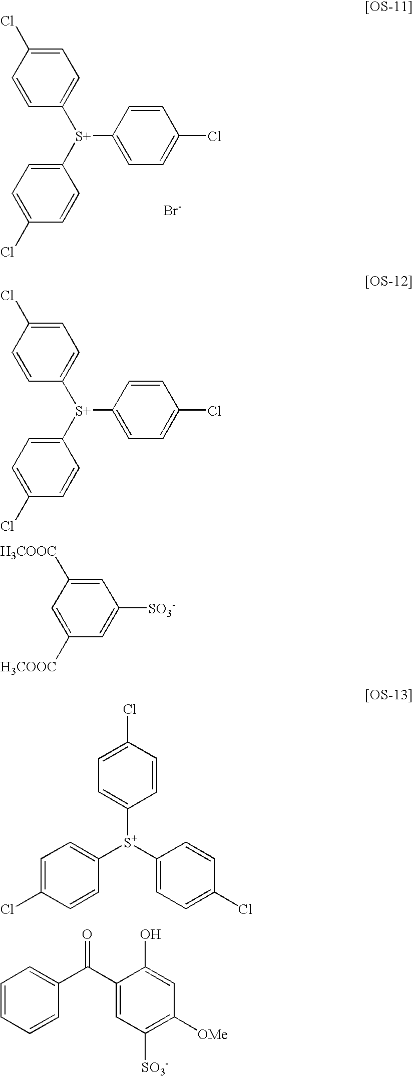

In addition to the compounds described above, at least one of specific aromatic sulfonium salts described in JP-A Nos. 2002-148790, 2002-350207, and 2002-46482 is also preferably used as the polymerization initiator.

In the invention, not only the sulfonium salt polymerization initiator, but also other polymerization initiator (other radical generator) may also be used as the polymerization initiator. Examples of such a radical generator include onium salts other than sulfonium salts, triazine compounds having at least one trihalomethyl group, peroxides, azo polymerization initiators, azide compounds, quinonediazide, activated halogen compounds, oxime ester compounds, triaryl monoalkyl borate compounds. Among them, an onium salt is preferably used, since it is highly sensitive. In addition, any of these polymerization initiators (radical generators) may be used together with the above-described sulfonium salt polymerization initiator, which may be used as the essential component.

Examples of the onium salts other than the sulfonium salts which onium salts can be preferably used in the invention include iodonium salts and diazonium salts. In the invention, these onium salts function as radical polymerization initiators rather than acid generators.

Such onium salts can be those represented by the following Formulae (2) and (3).
Ar²¹—I^{+—Ar}²²Z²¹⁻ Formula (2)
Ar³¹—N⁺≡N Z³¹⁻ Formula (3)
In Formula (2), Ar²¹ and Ar²² independently represent an aryl group having 20 or less carbon atoms which may have one or more substituents. Typical examples of the substituent which the aryl group may have include halogen atoms, a nitro group, alkyl groups having 12 or less carbon atoms, alkoxy groups having 12 or less carbon atoms, and aryloxy groups having 12 or less carbon atoms. Z²¹⁻ is a counter ion having the same definition as that of Z¹¹⁻.

In Formula (3), Ar³¹ represents an aryl group having 20 or less carbon atoms which may have one or more substituents. Typical examples of the substituents include halogen atoms, a nitro group, alkyl groups having 12 or less carbon atoms, alkoxy groups having 12 or less carbon atoms, aryloxy groups having 12 or less carbon atoms, alkylamino groups having 12 or less carbon atoms, dialkylamino groups having 12 or less carbon atoms, arylamino groups having 12 or less carbon atoms, and diarylamino groups having 12 or less carbon atoms. Z³¹⁻ is a counter ion having the same definition as that of Z¹¹⁻.

Typical examples of the onium salt represented by Formula (2) ([OI-1) to [OI-10]) and the onium salt represented by Formula (3) ([ON-1] to [ON-5]) preferably used in the invention are shown below, but the invention is not limited by these compounds.

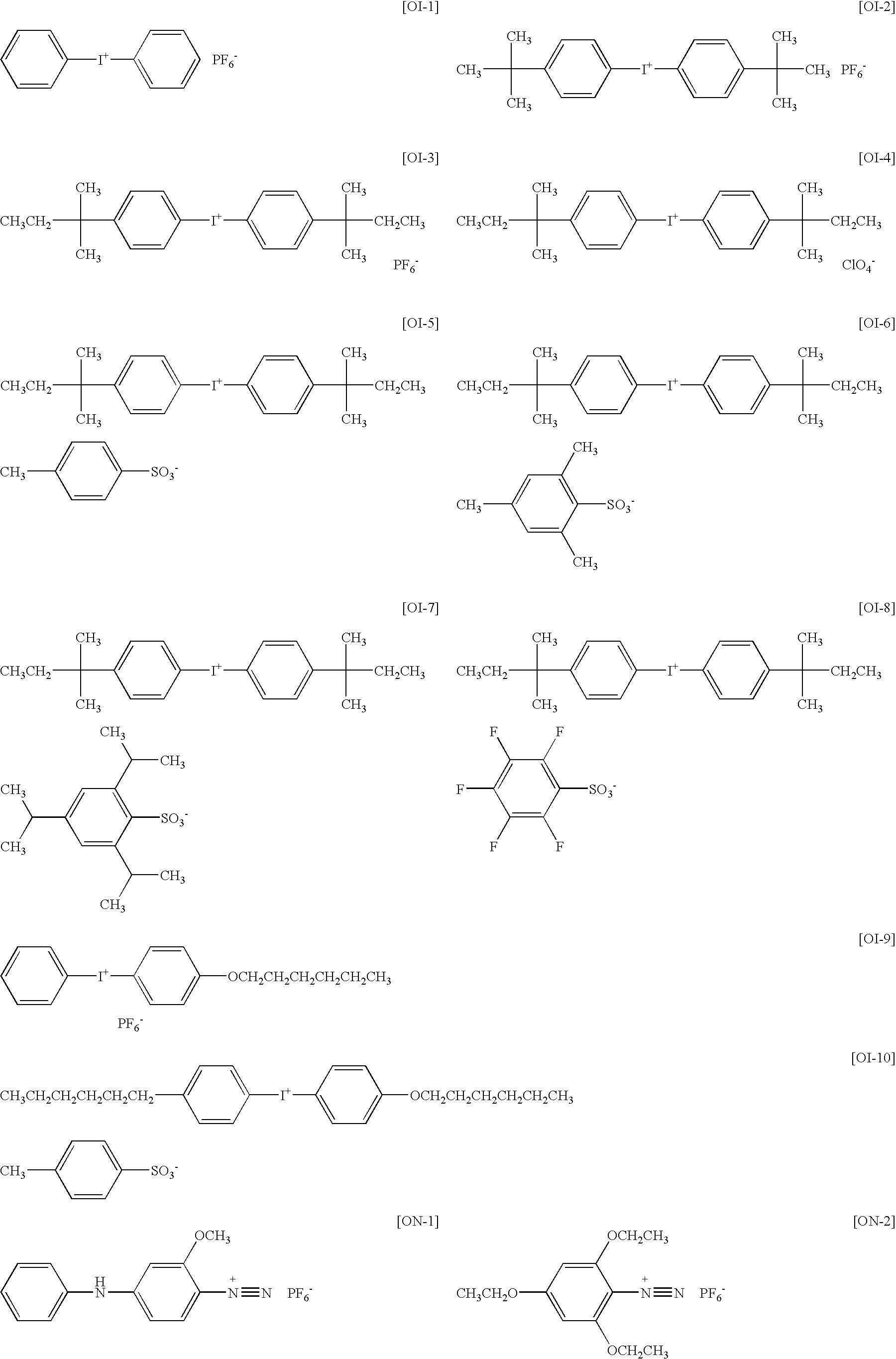

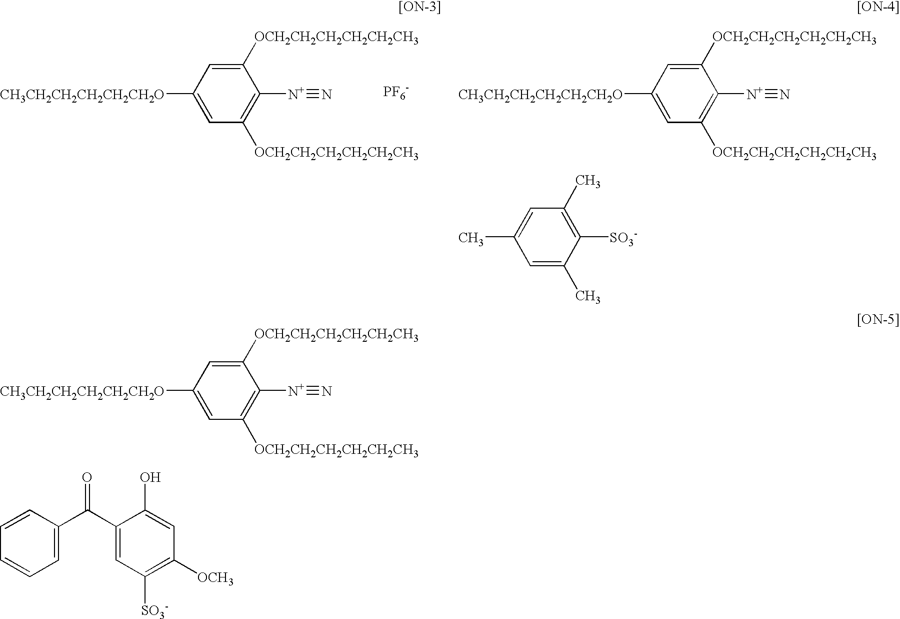

Examples of the onium salt preferably used as the polymerization initiator (radical generator) in the invention include those described in JP-A No. 2001-133696.

The polymerization initiator (radical generator) used in the invention preferably has a maximum absorption wavelength of 400 nm or less, and more preferably has a maximum absorption wavelength of 360 nm or less. When the radical generator has its absorption wavelength in the UV range as described above, the planographic printing plate precursor can be handled under a white lamp.

The total content of the polymerization initiator(s) in the invention is 0.1 to 50% by mass, preferably 0.5 to 30% by mass, and more preferably 1 to 20% by mass relative to all the solid matters of the image-recording layer from the viewpoints of sensitivity and prevention of stains on the non-image portions during printing.

In the invention, one polymerization initiator may be used or two or more polymerization initiators can be used together. When two or more polymerization initiators ate used together, two or more sulfonium salt polymerization initiators may be used, or a combination of a sulfonium salt polymerization initiator and any other polymerization initiator may be used.

When a sulfonium salt polymerization initiator and any other polymerization initiator are used together, the mass ratio of the sulfonium salt polymerization initiator to any other polymerization initiator is preferably 100/1 to 100/50 and more preferably 100/5 to 100/25.

In addition, the polymerization initiator and the other essential components may be contained in the same layer or different layers.

When a highly sensitive sulfonium salt, which is a preferable polymerization initiator, is contained in the image-recording layer in the invention, the radical polymerization reaction effectively proceeds and the formed image portions are very strong. Accordingly, when such an image-recording layer is combined with a protective layer described later, which has a high oxygen-blocking function, a planographic printing plate having very strong image portions can be produced, and consequently the printing plate has further improved printing durability. Further, the sulfonium salt polymerization initiator is superior in storability over time, and, when a planographic printing plate precursor including the sulfonium salt polymerization initiator is stored, an undesirable polymerization reaction is effectively suppressed.

Polymerizable Compound

The polymerizable compound used in the invention is an addition-polymerizable compound having at least one ethylenically unsaturated double bond, and is selected from compounds having at least one ethylenically unsaturated double bond, preferably 2 or more. Such compounds are widely known in the industrial field, and any of these compounds may be used in the invention without specific limitations. These have a chemical form of, for example, a monomer, a prepolymer (i.e., a dimer, a trimer and an oligomer), or a mixture thereof, or a copolymer of two or more of these compounds. Examples of the above monomer and the monomer of the copolymer include unsaturated carboxylic acids (e.g., acrylic acid, methacrylic acid, itaconic acid, crotonic acid, isocrotonic acid, and maleic acid), and esters and amides thereof. The polymerizable compound is preferably the ester of an unsaturated carboxylic acid and an aliphatic polyhydric alcohol compound, and/or the amide of an unsaturated carboxylic acid and an aliphatic polyvalent amine compound. In addition, the addition reaction product of an unsaturated carboxylic acid ester Or amide having at least one nucleophilic substituent such as a hydroxyl group, an amino group or a mercapto group, and a monofunctional or polyfunctional isocyanate or an epoxy compound; and the dehydration condensation reaction product of the above-described unsaturated carboxylic acid ester or amide and a monofunctional or polyfunctional carboxylic acid may also be preferably used as the polymerizable compound. Furthermore, the addition reaction product of an unsaturated carboxylic acid ester and amide having an electrophilic substituent such as an isocyanate group or an epoxy group, and a monofunctional or polyfunctional alcohol, amine or thiol; the substitution reaction product of an unsaturated carboxylic acid ester or amide having at least one leaving substituent such as a halogen atom or a tosyloxy group, and a monofunctional or polyfunctional alcohol, amine or thiol are also preferably used. Alternatively, those which are the same as the above except that the aforementioned unsaturated carboxylic acid is replaced with an unsaturated phosphonic acid, styrene, or vinylether may also be used.

Specific examples of the ester monomer of an aliphatic polyhydric alcohol compound and an unsaturated carboxylic acid include acrylates, methacrylates, itaconates, crotonates, isocrotonates, and maleates. Examples of the acrylates include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and polyester acrylate oligomer.

Examples of the methacrylates include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-3-methacryloxy-2-hydroxypropoxy)phenyl]dimethylmethane, and bis[p(methacryloxyethoxy)phenyl]dimethylmethane.

Examples of the itaconates include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of the crotonates include ethylene glycol dicrotonate, tetramethylene glycol dicrotonate, pentaerythritol dicrotonate, and sorbitol tetracrotonate.

Examples of the isocrotonates include ethylene glycol diisocrotonate, pentaerythritol diisocrotonate, and sorbitol tetraisocrotonate.

Examples of the maleates include ethylene glycol dimaleate, triethylene glycol dimaleate, pentaerythritol dimaleate, and sorbitol tetramaleate.

Examples of other esters include aliphatic alcohol esters described in Japanese Patent Application Publication (JP-B) Nos.46-27926 and 51-47334, and JP-A No. 57-196231, those having an aromatic skeleton and described in JP-A Nos. 59-5240, 59-5241 and 2-226149, those including at least one amino group and described in JP-A No. 1-165613, Moreover, two or more of these ester monomers may be used as a mixture.

Specific examples of the amide monomer of an aliphatic polyvalent amine compound and an unsaturated carboxylic acid include methylenebis-acrylamide, methylenebis-methacrylamide, 1,6-hexamethylenebis-acrylamide, 1,6-hexamethylenebis-methacrylamide, diethylene triamine trisacrylamide, xylylenebis-acrylamide, and xylylenebis-methacrylamide. Other examples of preferred amide monomers include those having a cyclohexylene structure and described in JP-B No. 54-21726.

Further, the polymerizable compound in the invention is also preferably an addition-polymerizable urethane compound produced by addition reaction of an isocyanate compound and a hydroxyl group-containing compound. Such a compound is, for example, a vinyl urethane compound described in JP-B No. 48-41708, containing two or more polymerizable vinyl groups in the molecule thereof, and produced by adding a hydroxyl group-containing vinyl monomer represented by the following Formula (b) to a polyisocyanate compound containing two or more isocyanate groups in the molecule thereof.
CH₂═C(R^{a})COOCH₂CH(R^{b})OH Formula (b)

In Formula (b), R^{a} and R^{b} independently represent H or CH₃.

Further, at least one of urethane acrylates described in JP-A No. 51-37193 and JP-B Nos. 2-32293 and 2-16765 and urethane compounds having an ethylene oxide skeleton and described in JP-B Nos. 58-49860, 56-17654, 62-39417 and 62-39418 may also be preferably used as the polymerizable compound. Furthermore, when at least one of addition-polymerizable compounds having an amino structure or a sulfide structure in the molecule thereof and described in JP-A Nos. 63-277653, 63-260909 and 1-105238 is used as the polymerizable compound, a photopolymerizable composition that is considerably excellent in photosensitizing speed may be obtained.

Other examples of the polymerizable compound include multifunctional acrylates and methacrylates such as polyester acrylates described in JP-A No. 48-64183, and JP-B Nos. 49-43191 and 52-30490, and epoxy acrylates obtained by reacting an epoxy resin with (meth)acrylic acid. Furthermore, at least one of specific unsaturated compounds described in JP-B Nos. 46-43946, 1-40337 and 1-40336, and vinylphosphonic acid compounds described in JP-A No. 2-25493 may also be used as the polymerizable compound. Moreover, at least one of compounds having a structure with at least one perfluoroalkyl group and described in JP-A No. 61-22048 may be appropriately used in some instances. In addition, at least one of photo-curable monomers and oligomers described in “Nippon Setchaku Kyokai Shi (Journal of Japanese Adhesive Society)”, Vol. 20, No. 7, pages 300-308 (1984) may also be used.

Details of the structure and the using method of the addition-polymerizable compound, for example, use of only one of the compounds, use of two or more of them, and the amount(s) of the compound(s), can be arbitrarily determined depending on desired performance of a final planographic printing plate precursor. For example, they are selected from the following viewpoints. From the viewpoint of photosensitizing speed, the addition-polymerizable compound preferably has many unsaturated groups in one molecule thereof, and, in many cases, is preferably bifunctional or more. In order to increase the strength of image portions, i.e. a cured layer, the addition-polymerizable compound is preferably trifunctional or more. Combined use of compounds (e.g. acrylates, methacrylates, styrene compounds, and vinyl ether compounds) having different functionalities and/or different polymerizable groups is effective in regulating both photosensitivity and strength of a planographic printing plate precursor. Although a high-molecular or highly hydrophobic compound has excellent photosensitizing speed and film strength, it may decelerate developing speed and/or easily precipitate in the developing solution, and is not, therefore, preferably used in some cases. Selection and use of the addition-polymerizable compound is an important factor for compatibility between the compound and other components (e.g. a binder polymer, an initiator, and a coloring agent) and dispersibility thereof in the image-recording layer composition. For example, the compatibility may be improved by using a compound having a low purity or a combination of two or more compounds.

In the planographic printing plate precursor of the invention, a compound having a specific structure may be selected for the purpose of improving adhesiveness between the photosensitive layer, and a support or a protective layer described later.

The content of the addition-polymerizable compound in the image-recording layer composition is preferably in the range of 5 to 80% by mass and more preferably in the range of 40 to 75% by mass relative to the solid matters in the image-recording layer composition from the viewpoints of sensitivity, phase separation, stickiness of the image-recording layer and the precipitating property of the addition-polymerizable compound in the developing solution.

One of these compounds may be used alone or two or more of them can be used together. In addition, as for use of the addition-polymerizable compound, the structure, the composition, and the addition amount thereof can be arbitrarily selected, considering the extent of inhibition of polymerization caused by oxygen, resolution and the fogging property, change in refractive index, and surface stickiness. Further, a layer configuration containing an undercoat and/or an overcoat and coating methods of these coatings may also be applied to the planographic printing plate precursor of the invention.

Binder Polymer

The image-recording layer in the invention preferably contains at least one binder polymer to improve film properties. Any of polymers which can improve the film properties may be used as the binder polymer.

The binder polymer in the invention preferably has at least one cross-linkable group in at least one side chain thereof.

The cross-linkable group cross-links the binder polymer molecules in the process of the radical polymerization reaction caused by exposing the planographic printing plate precursor to light and occurring in the image-recording layer. The cross-linkable group needs to have such a function and otherwise it is not particularly limited. The cross-linkable group is, for example, a functional group which can addition-polymerization react. Examples of such a functional group include ethylenic unsaturated-bond amino and epoxy groups.

Alternatively, the cross-linkable group may also be a functional group that can become a radical by photoirradiation, and examples of such a cross-linkable group include a thiol group, halogen groups, and onium salt structures. Among them, the cross-linkable group is preferably an ethylenic unsaturated bond group, and more preferably at least one of functional groups represented by the following Formulae (A) to (C).

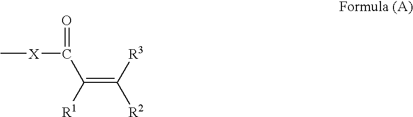

In Formula (A), R¹ to R³ independently represent a hydrogen atom or a monovalent substituent composed of at least one non-metal atom (including no metal atom).

R¹ is preferably a hydrogen atom, or an alkyl group that may have at least one substituent. Among them, R¹ is more preferably a hydrogen atom or a methyl group because of high radical reactivity.

R² and R³ independently represent a hydrogen or halogen atom, an amino group, a carboxyl group, an alkoxycarbonyl group, a sulfo group, a nitro group, a cyano group, an alkyl group that may have at least one substituent, an aryl group that may have at least one substituent, an alkoxy group that may have at least one substituent, an aryloxy group that may have at least one substituent, an alkylamino group that may have at least one substituent, an arylamino group that may have at least one substituent, an alkylsulfonyl group that may have at least one substituent, or an arylsulfonyl group that may have at least one substituent. Among them, each of R² and R³ is preferably a hydrogen atom, a carboxyl group, an alkoxycarbonyl group, an alkyl group that may have at least one substituent, or an aryl group that may have at least one substituent because of high radical reactivity.

X represents an oxygen or sulfur atom, or —N(R¹²)—; and R¹² represent a hydrogen atom or a monovalent organic group. R¹² is, for example, an alkyl group that may have at least one substituent. Among them, R¹² is preferably a hydrogen atom or a methyl, ethyl, or isopropyl group because of high radical reactivity.

Examples of the at least one substituent Include halogen atoms; alkyl, alkenyl, alkynyl, aryl, alkoxy, aryloxy, amino, alkylamino, arylamino, carboxyl, alkoxycarbonyl, sulfo, nitro, cyano, amide, alkylsulfonyl, and arylsulfonyl groups.

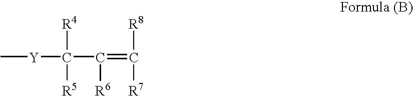

In Formula (B), R⁴ to R⁸ independently represent a hydrogen atom or a monovalent substituent composed of at least one non-metal atom (including no metal atom).

Each of R⁴ to R⁸ is preferably a hydrogen or halogen atom, an amino group, a dialkylamino group, a carboxyl group, an alkoxycarbonyl group, a sulfo group, a nitro group, a cyano group, an alkyl group that may have at least one substituent, an aryl group that may have at least one substituent, an alkoxy group that may have at least one substituent, an aryloxy group that nay have at least one substituent, an alkylamino group that may have at least one substituent, an arylamino group that may have at least one substituent, an alkylsulfonyl group that may have at least one substituent, or an arylsulfonyl group that may have at least one substituent. Among them, each of R⁴ to R⁸ is more preferably a hydrogen atom, a carboxyl group, an alkoxycarbonyl group, an alkyl group that may have at least one substituent, or an aryl group that may have at least one substituent.

Examples of the at least one substituent include those described in Formula (A). Y represents an oxygen or sulfur atom, or —N(R¹²)—. R¹² is the same as R¹² in Formula (A), and the typical examples thereof are also the same as those of R¹² in Formula (A).

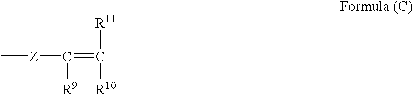

In Formula (C), R⁹ to R¹¹ independently represent a hydrogen atom or a monovalent substituent composed of at least one non-metal atom (including no metal atom).

R⁹ is preferably a hydrogen atom or an alkyl group that may have at least one substituent. Among them, R⁹ is more preferably a hydrogen atom or a methyl group because of high radical reactivity.

R¹⁰ and R¹¹ independently represent a hydrogen or halogen atom, an amino group, a dialkylamino group, a carboxyl group, an alkoxycarbonyl group, a sulfo group, a nitro group, a cyano group, an alkyl group that may have at least one substituent, an aryl group that may have at least one substituent, an alkoxy group that may have at least one substituent, an aryloxy group that may have at least one substituent, an alkylamino group that may have at least one substituent, an arylamino group that may have at least one substituent, an alkylsulfonyl group that may have a substituent group, or an arylsulfonyl group that may have at least one substituent. Among them, each of R¹⁰ and R¹¹ is preferably a hydrogen atom, a carboxyl group, an alkoxycarbonyl group, an alkyl group that may have at least one substituent, or an aryl group that may have at least one substituent because of high radical reactivity.

Examples of the at least one substituent include those described in Formula (A). Z represents an oxygen or sulfur atom, —N(R¹³)—, or a phenylene group that may have at least one substituent. R¹³ is, for example, an alkyl group that may have at least one substituent and is preferably a methyl, ethyl, or isopropyl group because of high radical reactivity.

The binder polymer having the cross-linkable group in at least one side chain thereof is preferably a high molecular-weight organic polymer which is soluble or swells in alkaline water because it needs to not only function as a film-forming agent to form the image-recording layer but also be soluble in a developing solution, preferably an alkaline developing solution. Therefore, the binder polymer used in the invention preferably has an alkali-soluble group in at least one side chain thereof as well as the cross-linkable group.

The alkali-soluble group containable in the binder polymer is preferably one selected from the group consisting of the following groups (1) to (6) from the viewpoint of solubility of the binder polymer in an alkaline developing solution, and the binder polymer preferably has a structural unit containing at least one of the following alkali-soluble groups.

(1) a phenolic hydroxyl group (—Ar—OH)

(2) a sulfonamide group (—SO₂NH—R)

(3) a substituted sulfonamide-containing acid group (hereinafter, referred to as “active imide group”) [—SO₂NHCOR, —SO₂NHSO₂R, or —CONHSO₂R]

(4) a carboxyl group (—CO₂H)

(5) a sulfonic group (—SO₃H)

(6) a phosphonooxy group (—OPO₃H₂)

In the groups (1) to (6), Ar represents a bivalent aryl connecting group that may have at least one substituent, and R represents a hydrogen atom or a hydrocarbon group that may have at least one substituent.

The binder polymer may have only one type of a structural unit having an alkali-soluble group (acidic group) selected from the groups (1) to (6), or may be a copolymer of two or more types of structural units having the same acidic group selected from the groups (1) to (6), or two or more types of structural units having different acidic groups selected from the groups (1) to (6).

<Specific Binder Polymer>

The binder polymer for use in the invention is more preferably has at least one repeating unit represented by the following Formula (i). Hereinafter, the binder polymer having a repeating unit represented by Formula (i), which is referred to as a specific binder polymer, will be described in detail.

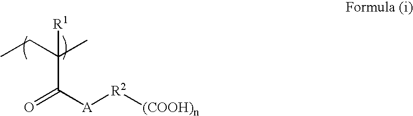

In Formula (i), R¹ represents a hydrogen atom or a methyl group; R² represents a connecting group which includes two or more atoms selected from the group consisting of carbon, hydrogen, oxygen, nitrogen and sulfur atoms and which has 2 to 82 atoms in total; A represents an oxygen atom or —NR³—; R³ represents a hydrogen atom or a monovalent hydrocarbon group having 1 to 10 carbon atoms; and n represents an integer of 1 to 5.

As described above, R¹ in Formula (i) represents a hydrogen atom or a methyl group, and is more preferably a methyl group.

The connecting group represented by R² in Formula (i) contains two or more atoms selected from the group consisting of carbon, hydrogen, oxygen, nitrogen and sulfur atoms. The connecting group has 2 to 82 atoms in total, preferably has 2 to 50 atoms in total, and more preferably has 2 to 30 atoms in total. When the connecting group has at least one substituent, the total number of atoms includes the number of atoms of the substituent(s). More specifically, the number of the atoms in the main skeleton of the connecting group represented by R² is preferably 1 to 30, more preferably 3 to 25, still more preferably 4 to 20, and most preferably 5 to 10. The term “main skeleton of the connecting group” refers to an atom or an atomic group connecting “A” and the terminal COOH group in Formula (i). When the connecting group has a plurality of connecting routes which connect “A” and the terminal COOH group, the main skeleton of the connecting group refers to an atom or an atomic group forming the shortest connection route between “A” and the terminal COOH group. Accordingly, when the connecting group includes a cyclic structure therein, number of the atoms to be counted depends on the connecting positions of “A” and the terminal COOH group (e.g., ortho, meta, or para).

Specific examples of the connecting group include substituted or unsubstituted alkylene, substituted or unsubstituted arylene, and groups in which two or more of these bivalent groups are connected via at least one amide or ester bond.

When the connecting group has a chain structure, it can be ethylene, or propylene, or a group in which two or more of these alkylene groups are connected to each other via at least one ester bond.

The connecting group represented by R² in Formula (i) is preferably a hydrocarbon group having an aliphatic cyclic structure with 3 to 30 carbon atoms and a valence of (N+1). Specific examples of such a group include hydrocarbon groups having a valence of (N+1) and obtained by removing (n+1) hydrogen atoms each bonding to one of the carbon atoms of an alicyclic hydrocarbon compound, such as cyclopropane, cyclopentane, cyclohexane, cycloheptane, cyclooctane, cyclodecane, dicyclohexyl, tercyclohexyl, and norbornane, which may have one or more substituents. In addition, R² preferably has 3 to 30 carbon atoms which include the carbon atoms of the substituent(s).

R² can be a group obtained by substituting one or more carbon atoms of the hydrocarbon group having an aliphatic cyclic structure with 3 to 30 carbon atoms and a valence of (N+1) with at least one hetero atom selected from nitrogen, oxygen and sulfur atoms. In view of printing durability, R² is preferably a hydrocarbon group which has an aliphatic cyclic structure, a valence of (n+1), 5 to 30 carbon atoms and two or more rings, and which may have at least one substituent, such as a condensed polycyclic aliphatic hydrocarbon group, a cross-linked alicyclic hydrocarbon group, a spiro aliphatic hydrocarbon group or a group having aliphatic hydrocarbon rings connected with each other via a bond or a connecting group. In this case, the number of carbon atoms involves the number of the carbon atoms included in the substituent(s).

The connecting group represented by R² is particularly preferably a group containing a main skeleton with 5 to 10 carbon atoms. Such a group preferably has a chain structure containing at least one ester bond in the structure thereof or the cyclic structure described above.

The substituent which the connecting group represented by R² is, for example, a monovalent non-metal atomic group which is other than a hydrogen atom. Examples thereof include halogen atoms (—F, —Br, —Cl and —I), a hydroxyl group, alkoxy groups, aryloxy groups, a mercapto group, alkylthio groups, arylthio groups, alkyldithio groups, aryldithio groups, an amino group, N-alkylamino groups, N,N-dialkylamino groups, N-arylamino groups, N,N-diarylamino groups, N-alkyl-N-arylamino groups, acyloxy group, a carbamoyloxy group, N-alkylcarbamoyloxy groups, N-arylcarbamoyloxy groups, N,N-dialkylcarbamoyloxy groups, N,N-diarylcarbamoyloxy groups, N-alkyl-N-arylcarbamoyloxy groups, alkylsulfoxy groups, arylsulfoxy groups, acylthio groups, acylamino groups, N-alkylacylamino groups, N-arylacylamino groups, an ureido group, N′-alkylureido groups, N′,N′-dialkylureido groups, N′-arylureido groups, N′,N′-diarylureido groups, N′-alkyl-N′-arylureido groups, N-alkylureido groups, N-arylureido groups, N′-alkyl-N-alkylureido groups, N′-alkyl-N-arylureido groups, N′,N′-dialkyl-N-alkylureido groups, N′,N′-dialkyl-N-arylureido groups, N′-aryl-N-alkylureido groups, N′-aryl-N-arylureido groups, N′,N′-diaryl-N-alkylureido groups, N′,N′-diaryl-N-arylureido groups, N′-alkyl-N′-aryl-N-alkylureido groups, N′-alkyl-N′-aryl-N-arylureido groups, alkoxycarbonylamino groups, aryloxycarbonylamino groups, N-alkyl-N-alkoxycarbonylamino groups, N-alkyl-N-aryloxycarbonylamino groups, N-aryl-N-alkoxycarbonylamino groups, N-aryl-N-aryloxycarbonylamino groups, a formyl group, acyl groups, a carboxyl group and conjugated base groups thereof, alkoxycarbonyl groups, aryloxycarbonyl groups, a carbamoyl group, N-alkylcarbamoyl groups, N,N-dialkylcarbamoyl groups, N-arylcarbamoyl groups, N,N-diarylcarbamoyl groups, N-alkyl-N-arylcarbamoyl groups, alkylsulfinyl groups, arylsulfinyl groups, alkylsulfonyl groups, arylsulfonyl groups, a sulfo group (—SO₃H) and conjugated base groups thereof, alkoxysulfonyl groups, aryloxysulfonyl groups, a sulfinamoyl group, N-alkylsulfinamoyl groups, N,N-dialkylsulfinamoyl groups, N-arylsulfinamoyl groups, N,N-diarylsulfinamoyl groups, N-allyl-N-arylsulfinamoyl groups, a sulfamoyl group, N-alkylsulfamoyl groups, N,N-dialkylsulfamoyl groups, N-arylsulfamoyl groups, N,N-diarylsulfamoyl groups, N-alkyl-N-arylsulfamoyl groups, N-acylsulfamoyl groups and conjugated base groups thereof, N-alkylsulfonylsulfamoyl groups (—SO₂NHSO₂(alkyl)) and conjugated base groups thereof, N-arylsulfonylsulfamoyl groups (—SO₂NHSO₂(aryl)) and conjugated base groups thereof, N-alkylsulfonylcarbamoyl groups (—CONHSO₂(alkyl)) and conjugated base groups thereof, N-arylsulfonylcarbamoyl groups (—CONHSO₂(aryl)) and conjugated base groups thereof, alkoxysilyl groups (—Si(Oalkyl)₃), aryloxysilyl groups (—Si(Oaryl)₃), a hydroxysilyl group (—Si(OH)₃) and conjugated base groups thereof, a phosphono group (—PO₃H₂) and conjugated base groups thereof, dialkylphosphono groups (—PO₃(alkyl)₂), diarylphosphono groups (—PO₃(aryl)₂), alkylarylphosphono groups (—PO₃(alkyl)(aryl)), monoalkylphosphono groups (—PO₃H(alkyl)) and conjugated base groups thereof, monoarylphosphono groups (—PO₃H(aryl)) and conjugated base groups thereof, a phosphonooxy group (—OPO₃H₂) and conjugated base groups thereof, dialkylphosphonoxy groups (—OPO₃(alkyl)₂), diarylphosphonoxy groups (—OPO₃(aryl)₂), alkylarylphosphonoxy groups (—OPO₃(alkyl)(aryl)), monoalkylphosphonoxy groups (—OPO₃H(alkyl)) and conjugated base groups thereof, monoarylphosphonoxy groups (—OPO₃H(aryl)) and conjugated base groups thereof, a cyano group, a nitro group, dialkylboryl groups (—B(alkyl)₂), diarylboryl groups (—B(aryl)₂), alkylarylboryl groups (—B(alkyl)(aryl)), a dihydroxyboryl group (—B(OH)₂) and conjugated base groups thereof, alkylhydroxyboryl groups (—B(alkyl)OH)) and conjugated base groups thereof, arylhydroxyboryl groups (—B(aryl)(OH)) and conjugated base groups thereof, aryl groups, alkenyl groups, and alkynyl groups.

In the planographic printing plate precursor of the invention, a substituent having at least one hydrogen atom capable of forming a hydrogen bond, particularly, a substituent having a smaller acid dissociation constant (pKa) than carboxylic acid is not preferred, because it tends to deteriorate printing durability. However, such a substituent may be present depending on the design of the image-recording layer. A halogen atom, or a hydrophobic substituent such as a hydrocarbon group (e.g., an alkyl group, an aryl group, an alkenyl group or an alkynyl group), an alkoxy group or an aryloxy group is preferred because it tends to improve printing durability. In particular, when the cyclic structure is a monocyclic aliphatic hydrocarbon with a ring skeleton having 6 or less atoms, such as cyclopentane or cyclohexane, it preferably has the hydrophobic substituent(s). These substituents, or at least one of them and the hydrocarbon group to which the substituent binds may form a ring, if possible. In addition, the substituent may have at least one substituent.

When A in Formula (i) is NR³—, R³ represents a hydrogen atom or a monovalent hydrocarbon group having 1 to 10 carbon atoms. The monovalent hydrocarbon group having 1 to 10 carbon atoms and represented by R³ can be an alkyl group, an aryl group, an alkenyl group, or an alkynyl group.

The alkyl group may be a linear, branched, or cyclic alkyl group having 1 to 10 carbon atoms. Typical examples thereof include a methyl group, an ethyl group, a propyl group, a butyl group, a pentyl group, a hexyl group, a heptyl group, an octyl group, a nonyl group, a decyl group, an iso-propyl group, an iso-butyl group, a sec-butyl group, a tert-butyl group, an iso-pentyl group, a neopentyl group, a 1-methylbutyl group, an iso-hexyl group, a 2-ethylhexyl group, a 2-methylhexyl group, a cyclopentyl group, a cyclohexyl group, a 1-adamantyl group, and a 2-norbornyl group.

The aryl group may be one having 6 to 10 carbon atoms or a hetero aryl group having 1 to 10 carbon atoms and containing at least one hetero atom selected from the group consisting of nitrogen, oxygen and sulfur atoms. Examples of the former include a phenyl group, a naphthyl group, and an indenyl group. Examples of the latter include a furyl group, a thienyl group, a pyrrolyl group, a pyridyl group, and a quinolyl group.

The alkenyl group may be a linear, branched, or cyclic alkenyl group having 2 to 10 carbon atoms. Typical examples thereof include a vinyl group, a 1-propenyl group, a 1-butenyl group, a 1-methyl-1-propenyl group, a 1-cyclopentenyl group, and a 1-cyclohexenyl group.

The alkynyl group may have 2 to 10 carbon atoms, and examples thereof include an ethynyl group, a 1-propynyl group, a 1-butynyl group, and a 1-octynyl group. R³ may have one or more substituents, and examples of the substituent(s) are the same as those of the substituent which R² may have. However, the total number of the carbon atoms of R³ including the number of the carbon atoms of the substituent(s) is 1 to 10.

“A” in Formula (i) is preferably an oxygen atom or —NH—, since a compound including such “A” is easy to produce

“n” in Formula (i) is an integer of 1 to 5, and preferably 1 from the viewpoint of printing durability.

Typical examples of the repeating unit represented by Formula (i) are shown below, but the invention is not limited by these examples.

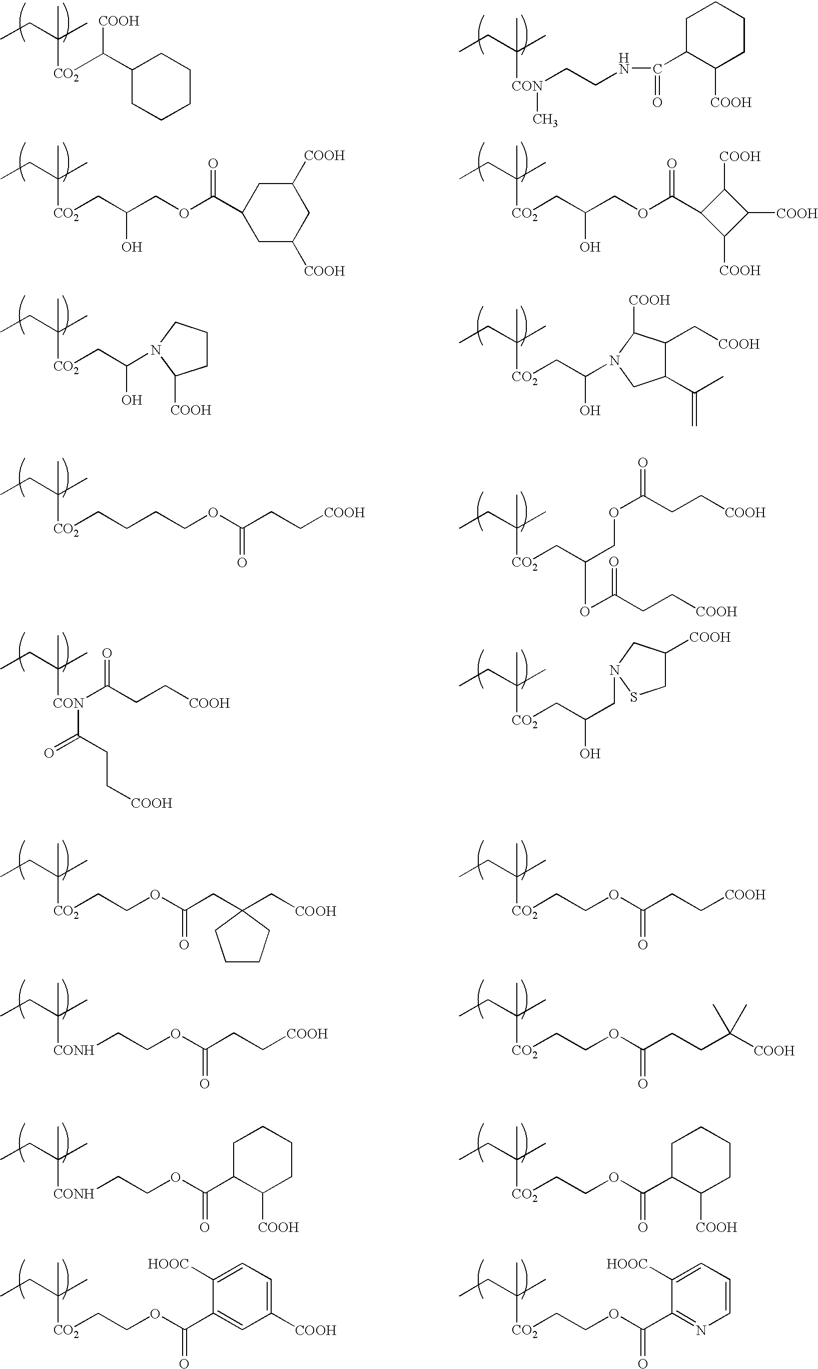

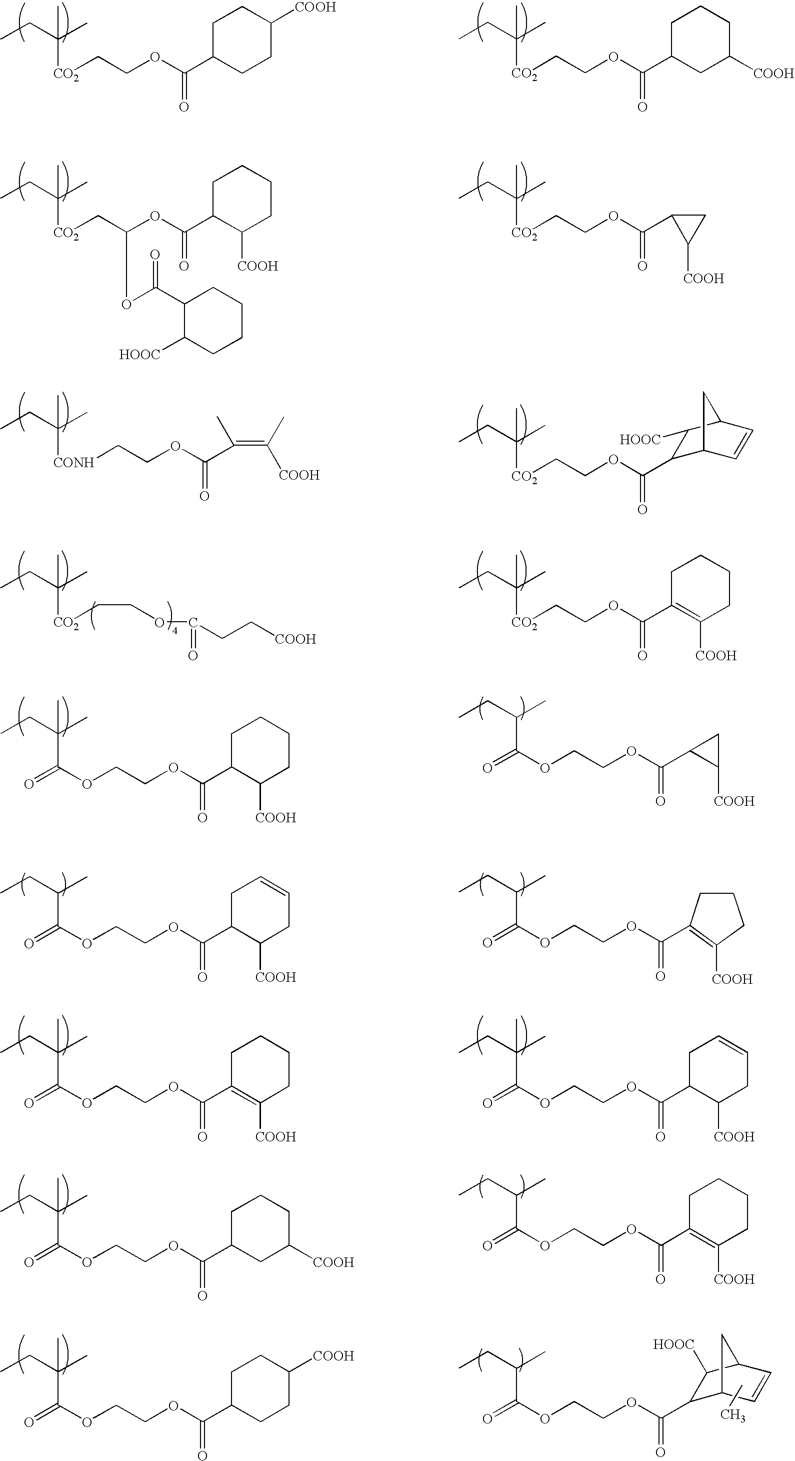

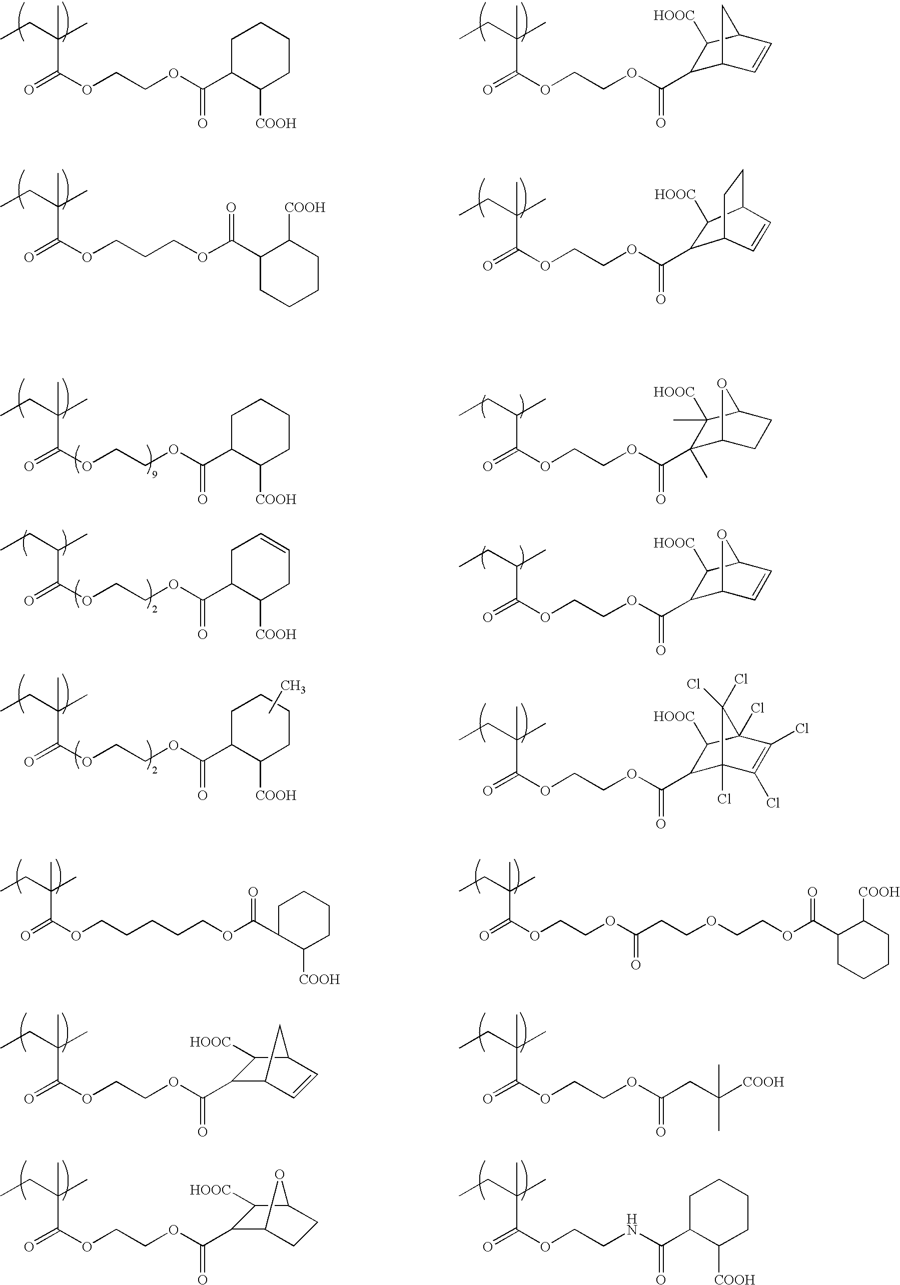

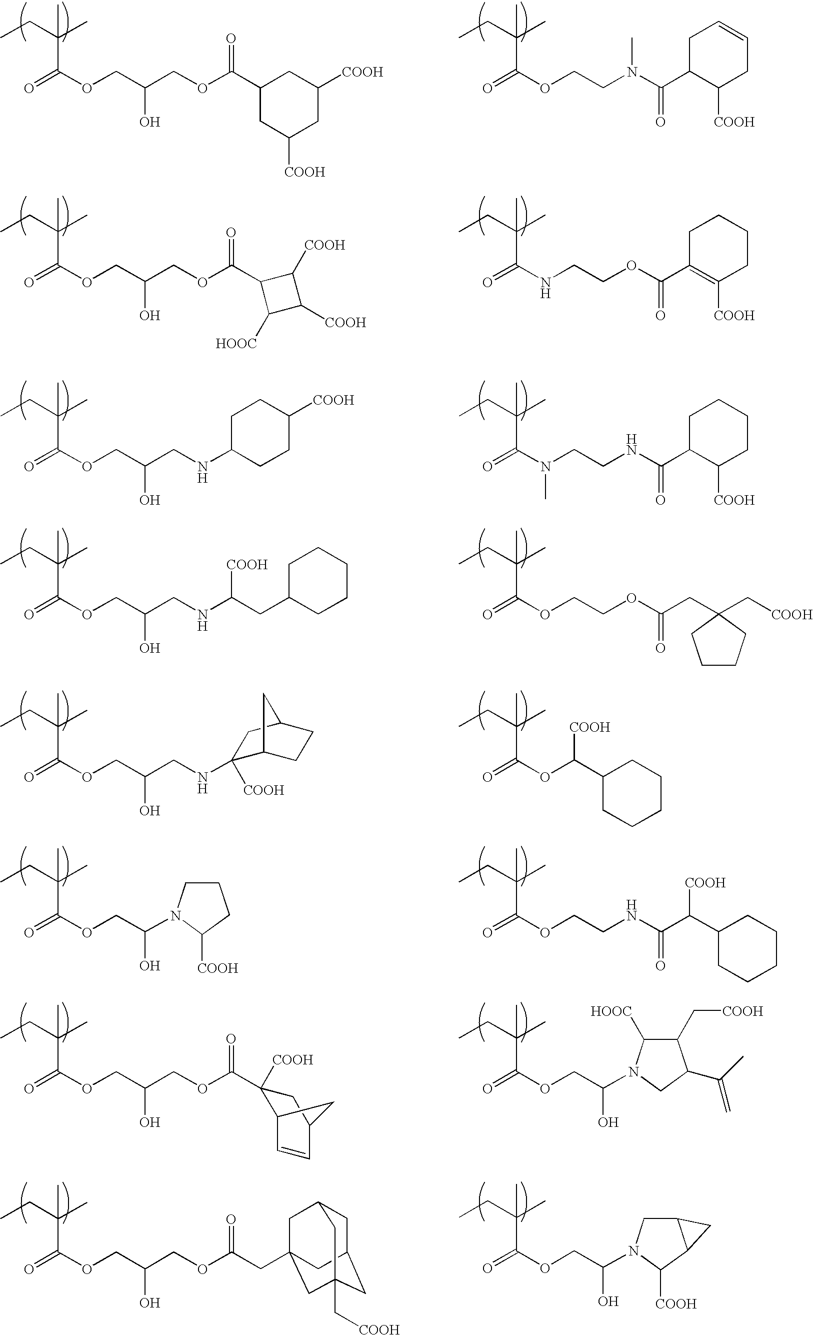

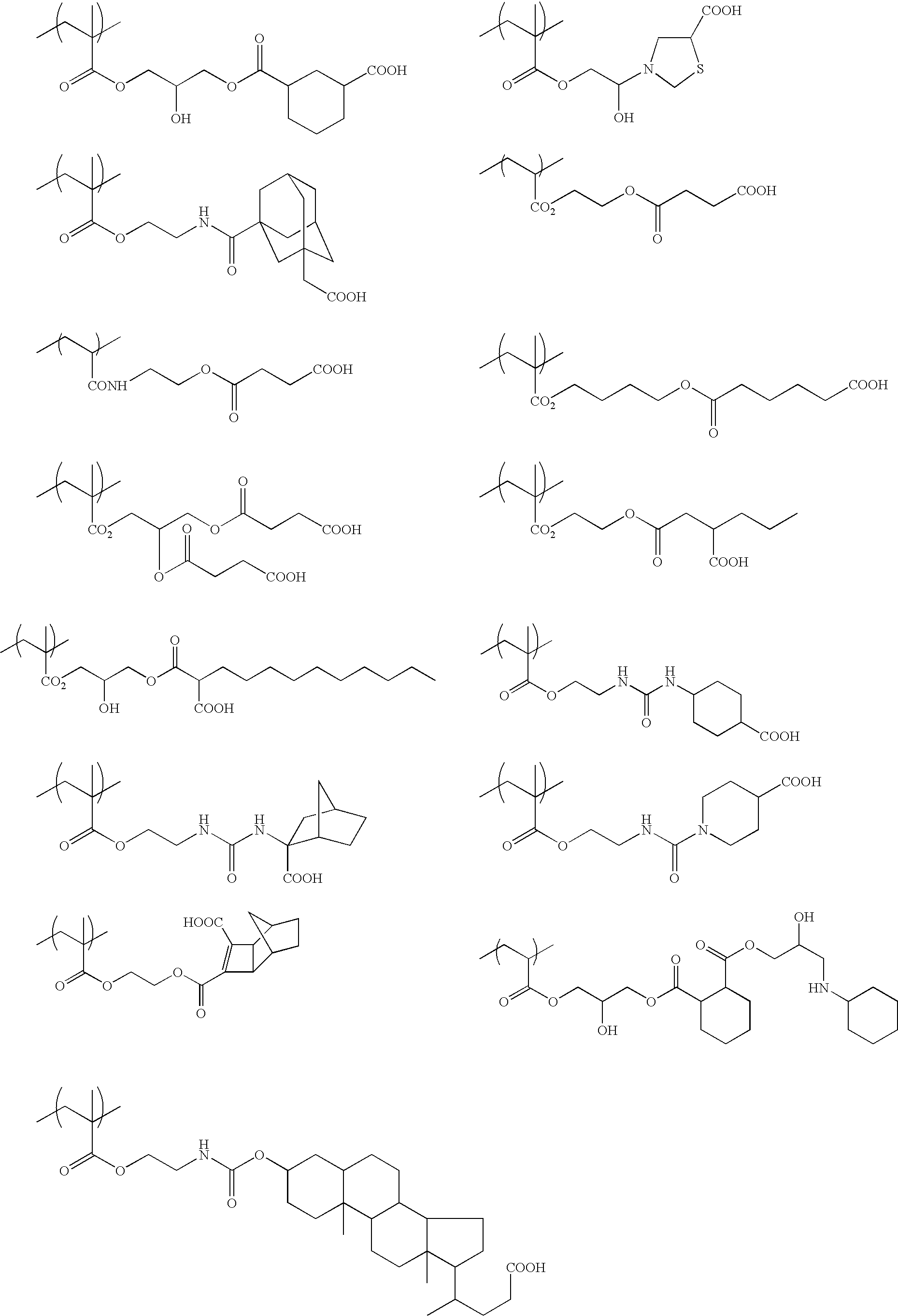

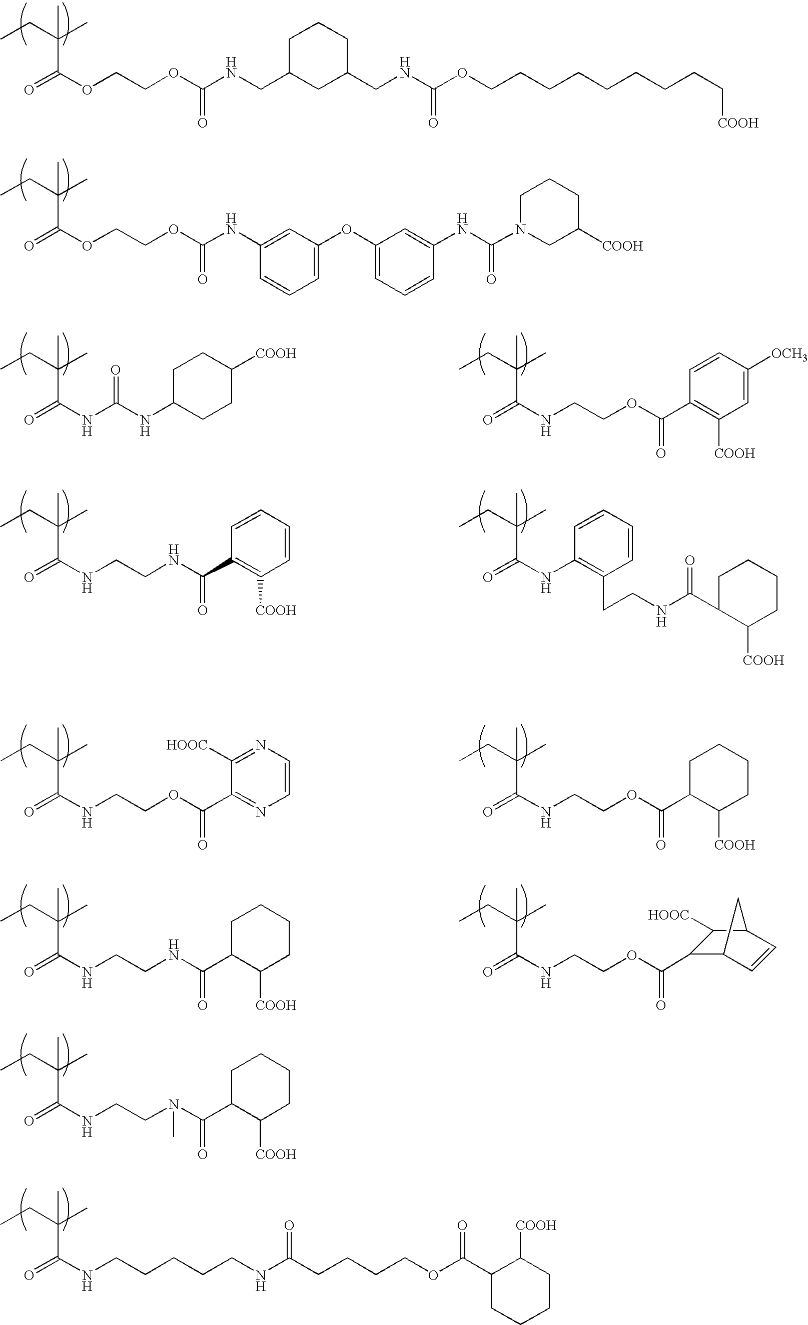

The binder polymer may have one or more repeating units represented by Formula (i). The specific binder polymer used in the invention may be a polymer consisting of the repeating unit(s) represented by Formula (i), but is usually a copolymer obtained by polymerizing at least one monomer including the repeating unit represented by Formula (i) and at least one other copolymerizable monomer. A desired total content of the repeating unit(s) represented by Formula (i) in the copolymer is suitably determined according to a desired structure of the polymer, and a desired composition for an image-recording layer. The total content of the repeating unit(s) is preferably in the range of 1 to 99 mole %, more preferably 5 to 40 mole %, and still more preferably 5 to 20 mole % relative to the total mole number of the polymer components.

When the binder polymer is a copolymer, the copolymerizable monomer may be any of conventionally known monomers that are radically polymerizable. Specific examples thereof include monomers described in Kobunshi Data Handbook (Polymer Data Handbook), Kiso-hen (Fundamental Book) edited by Kobunshi Gakkai (Society of Polymer Science, Japan), and published by Baifukan Co., Ltd. in 1986. One or more of such copolymerizable monomers may be used.

A desired molecular weight of the specific binder polymer used in the invention is determined suitably, considering the image-forming property thereof and printing durability of the precursor. The molecular weight is preferably in the range of 2,000 to 1,000,000, more preferably in the range of 5,000 to 500,006, and still more preferably in the range of 10,000 to 200,000.

One of the specific binder polymers may be used alone, or at least one of the specific binder polymers can be used together with any other binder polymer(s) in the invention. Other binder polymer(s) is contained in an amount of 1 to 60% by mass, preferably from 1 to 40% by mass, and still more preferably from 1 to 20% by mass, based on the total mass of the binder polymer(s) used. The binder polymer(s) other than the specific binder polymer(s) can be any of conventionally known binder polymers. Specifically, it is preferably a binder having an acrylic main chain, or a urethane binder, which is widely employed in the art.

A desired total content of the specific binder polymer(s) and other binder polymer(s) in the image-recording layer composition may be appropriately determined. The total content of these binder polymer(s) is usually in the range of 10 to 90% by mass, preferably 20 to 80% by mass, and still more preferably 30 to 70% by mass relative to the total mass of the nonvolatile components in the image-recording layer composition.

In addition, the acid value (meg/g) of the binder polymer(s) is preferably in the range of 2.00 to 3.60.

Other Binder Polymer(s) Usable Together with Specific Binder Polymer(s)

The binder polymer(s) other than the specific binder polymer(s) and usable together with the specific binder polymer(s) preferably has at least one radically polymerizable group.

The radically polymerizable group needs to be polymerizable due to a radical or radicals, and otherwise it is not limited. Examples thereof include α-substituted methylacryl groups (—OC(═O)—C(—CH₂Z)=CH₂ wherein Z is a hydrocarbon group with a hetero atom bonding to —CH₂ group, an acrylic group, a methacrylic group, an allyl group, and a styryl group. The radically polymerizable group is preferably an acrylic group or a methacrylic group.

The content of the radically polymerizable group(s) in the binder polymer(s), specifically, the content of the radically polymerizable unsaturated double bonds determined by iodimetry, is preferably 0.1 to 10.0 mmol, more preferably 1.0 to 7.0 mmol, and most preferably 2.0 to 5.5 mmol per gram of the binder polymer(s) from the viewpoints of sensitivity and storage stability.

In addition, it is preferable that other binder polymer further has at least one alkali-soluble group. The content of the alkali-soluble group(s) in the binder polymer(s), or, in other words, the acid value of the binder polymer(s) determined by neutralization titration, is preferably 0.1 to 3.0 mmol, more preferably 0.2 to 2.0 mmol, and most preferably 0.45 to 1.0 mmol per gram of the binder polymer from the viewpoints of precipitation of development scums and printing durability.

The weight-average molecular weight of each of such binder polymer(s) is preferably in the range of 2,000 to 1,000,000, more preferably in the range of 10,000 to 300,000, and most preferably in the range of 20,000 to 200,000 from the viewpoints of the film-forming property (printing durability) of the binder polymer and the solubility of the binder polymer in a coating solvent.

Further, the glass transition temperature (Tg) of the binder polymer(s) is preferably in the range of 70 to 300° C., more preferably in the range of 80 to 250° C., and most preferably in the range of 90 to 200° C. from the viewpoints of storage stability, printing durability, and sensitivity.

The binder polymer(s) preferably has at least one amide and/or imide group in the molecule thereof, and more preferably has at least one methacrylamide and/or methacrylamide derivative in order to raise the glass transition temperature of the binder polymer(s).

Other Components

The image-recording layer in the invention may contain not only the aforementioned essential components but also other component(s) which is suitable for the intended use and the production method, if necessary. Preferred additives will be described below.

Colorant

The image-recording layer in the invention may contain at least one of dyes and pigments to dye the image-recording layer. This can improve visibility of the image on a printing plate obtained by printing plate-making, and the so-called inspectability of the printing plate, such as suitability for an image density measuring device. Specific examples of the pigment include phthalocyanine pigments, azo pigments, carbon black, and titanium oxide. Specific examples of the dye include ethyl violet, crystal violet, azo dyes, anthraquinone dyes, and cyanine dyes. The colorant is preferably a cationic dye.

The content of the dye(s) and pigment(s) serving as the colorants is preferably about 0.5 to about 5% by mass relative to the non-volatile components of the image-recording layer composition.

Polymerization Inhibitor

The image-recording layer in the invention preferably contains a small amount of a thermal polymerization inhibitor in order to inhibit undesired thermal polymerization of the compound having at least one polymerizable ethylenically unsaturated double bond, namely the polymerizable compound. Typical examples of the thermal polymerization inhibitor include hydroquinone, p-methoxyphenol, di-t-butyl-p-cresol, pyrogallol, t-butylcatechol, benzoquinone, 4,4′-thiobis(3-methyl-6t-butylphenol), 2,2′-methylenebis(4-methyl-6-t-butylphenol), and a primary cerium salt of N-nitrosophenylhydroxyamine. The content of the thermal polymerization inhibitor contained is preferably about 0.01 to about 5% by mass with respect to the total mass of the nonvolatile components contained in the image-recording layer composition. In order to prevent oxygen from inhibiting the polymerization, the image-recording layer composition may also include at least one higher fatty acid derivative such as behenic acid or behenic acid amide, which is made to exist mainly in the surface portion of the layer during drying of the applied coating. The content of the at least one higher fatty acid derivative contained is preferably about 0.5 to about 10% by mass with respect to the mass of the nonvolatile components contained in the image-recording layer composition.

Other Additive

In addition, the image-recording layer in the invention may contain at least one other known additive such as an inorganic filler for improving the physical properties of a cured film, a plasticizer, and a sensitizing agent for improving the property of the image-recording layer surface by which property an ink easily adheres to the layer surface. Examples of the plasticizer include dioctyl phthalate, didodecyl phthalate, triethylene glycol dicaprylate, dimethyl glycol phthalate, tricresyl phosphate, dioctyl adipate, dibutyl sebacate, and triacetylglycerin. The content of the plasticizer(s) is generally in the range of 10% by mass or less relative to the total mass of the binder polymer(s) and the addition-polymerizable compound(s).

Further, the image-recording layer may contain at least one UV initiator, and/or at least one thermal cross-linking agent in order to enhance the effects of heating and exposure of the developed layer and thus improve the film strength (printing durability) described later.

[Protective Layer]

In the invention, a protective layer is preferably formed on the image-recording layer.

The protective layer in the invention preferably contains a lamellar inorganic compound.

The planographic printing plate precursor of the invention, which has a negative-type polymerizable image-recording layer, is usually exposed to light in air, and, therefore, further has the protective layer on the image-recording layer to prevent undesired incorporation of low-molecular weight compounds, such as oxygen, moisture, and basic substances, present in air that inhibit image-forming reaction, into the image-recording layer.

Since the protective layer provided for such a purpose includes the lamellar inorganic compound in the invention, the protective layer has both a matting property and improved film strength. As a result, oxygen can be blocked, and deterioration of the protective layer due to deformation can be prevented, and the matting property can be obtained. Thereby, even if the planographic printing plate precursors are stacked without insert paper, it is possible to prevent adhesion between the image-recording layer-side surface (protective layer surface) of a planographic printing plate precursor and the support-side surface of the adjacent planographic printing plate precursor.

Hereinafter, the lamellar inorganic compound will be described.

Lamellar Inorganic Compound

The lamellar inorganic compound for use in the invention is in the form of particles having a thin tabular shape. Examples thereof natural and synthetic micas represented by the Formula of A(B, or C)₂ -5D₄O₁₀(OH, A, or O)₂ (wherein A is K, Na, or Ca; each of B and C is Fe(II), Fe(III), Mn, Al, Mg, or V; and D is Si or Al); talc represented by the Formula of 3MgO.4SiO.H₂O; teniolite, montmorillonite, saponite, hectolite, and zirconium phosphate.

As for the micas, examples of the natural micas include muscovite, soda mica, phlogopite, biotite, and lepidolite. Examples of the synthetic micas include non-swelling micas such as fluorinated phlogopite KMg₃(AlSi₃O₁₀)F₂ and potassium tetrasilicic mica KMg_{2.5}Si₄O₁₀)F₂; and swelling micas such as sodium tetrasilicic mica NaMg_{2.5}(Si₄O₁₀)F₂, sodium or lithium teniolite (Na, or Li)Mg₂Li(Si₄O₁₀)F₂, and montmorillonite sodium or lithium hectolite (Na, or Li)_{1/8}Mg_{2/5}Li_{1/8}(Si₄O₁₀)F₂. The lamellar inorganic compound may also be synthetic smectite.

Among the above compounds, the lamellar inorganic compound in the invention is preferably fluorinated swelling mica, which is a synthetic lamellar inorganic compound. Such swelling synthetic mica and swelling clay minerals such as montmorillonite, saponite, hectolite, and bentonite have a laminated structure composed of unit crystal lattice layers and having a thickness of approximately 10 to 15 Å, and the metal atom(s) introduced into the lattice is significantly larger than that in other clay minerals. As a result, the lattice layers become short of positive charges and adsorb cations such as Na⁺, Ca²⁺, and/or Mg²⁺ therebetween to compensate for the shortage. The cations between the lattice layers, which are called exchangeable cations, can be replaced with various cations. In particular, when each of the cations is Li⁺ or Na⁺, which has a small ionic radius, the bonds between the lamellar crystal lattices are weak and such mica swells significantly in the presence of water. When shear is applied to mica which has swelled, the mica easily cleaves and forms a stable sol in water. Bentonite and swelling synthetic micas have such a tendency strongly, and are thus useful. The lamellar inorganic compound in the invention is particularly preferably swelling synthetic mica.

As for the shape of the lamellar inorganic compound for use in the invention, the thickness is preferably as small as possible from the viewpoint of diffusion control. The plane size is preferably larger as far as the smoothness of a coated surface or the transmission of activated light is not impaired. Thus, the aspect ratio is generally 20 or more, preferably 100 or more, and more preferably 200 or more. The aspect ratio is a ratio of the thickness of a particle to the length (major axis) of the particle, and is obtained, for example, from the projected drawing of the particle in a micrograph. The greater the aspect ratio of mica particles is, the greater the effect is.

The average thickness (major axis) of the lamellar inorganic compound particles for use in the invention is preferably 0.3 to 20 μm, preferably 0.5 to 10 μm, and more preferably 1 to 5 μm. The average thickness of the particles is preferably 0.1 μm or less, more preferably 0.05 μm or less, and more preferably 0.01 μm or less. For example, swelling synthetic mica particles, which are a typical example of the lamellar inorganic compound, have a thickness of 1 to 50 nm and a planar size (major axis) of approximately 1 to 20 μm.

The content of the lamellar inorganic compound contained in the protective layer is preferably in the range of 5 to 55% by mass, and more preferably 10 to 40% by mass relative to the total mass of the solid matters in the protective layer. When the content is less than 5% by mass, such a small amount of the lamellar inorganic compound is not effective in suppressing adhesion of the planographic printing plate precursors. When the content is more than 55% by mass, a protective layer coating solution including such a large amount of the lamellar inorganic compound results in formation of an unsatisfactory coated film, which cannot prevent deterioration in sensitivity.

When plural lamellar inorganic compounds are used, the total content of these lamellar inorganic compounds is preferably within the above range.

Binder

The protective layer formed on the negative-type polymerizable image-recording layer in the invention is basically required to have a low transmission with respect to low-molecular weight compounds such as oxygen, not to hinder substantially exposure light from passing through the protective layer, to have good adhesion to the image-recording layer, and to be easily removable in the developing process conducting after exposure.

There are many studies concerning protective layers, and some of them are described in detail in U.S. Pat. No. 3,458,311 and JP-B No. 55-49729. The material used in the protective layer is preferably a water-soluble polymer compound having relatively high crystallinity. Typical examples thereof include polyvinyl alcohol, polyvinylpyrrolidone, acidic celluloses, gelatin, gum arabic, and polyacrylic acid. Inclusion of polyvinyl alcohol as the main component of the protective layer is most effective in improving the basic properties of the protective layer such as the oxygen-blocking property and removability during development.

When the protective layer in the invention includes the water-soluble polymer compound serving as a binder as well as the lamellar inorganic compound, the protective layer can have various properties required for the protective layer.

A part of the hydroxyl groups of polyvinyl alcohol, which is preferably used-as the binder of the protective layer, may be substituted with ester, ether and/or acetal, as long as the substituted polyvinyl alcohol still contains at least one unsubstituted vinyl alcohol unit to provide desired oxygen-blocking property and solubility in water. Alternatively, polyvinyl alcohol may contain at least one other copolymerization moiety in the structure thereof. Polyvinyl alcohol can be one obtained by hydrolyzing 71 to 100% of the acetate residues of polyvinyl acetate and having a molecular weight in the range of 300 to 2,400. Specific examples thereof include PVA-105, PVA-110, PVA-117, PVA-117H, PVA-120, PVA-124, PVA-124H, PVA-CS, PVACST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, L-8, KL-318, and KL-506 all manufactured by Kuraray Co. Ltd.

The components of the protective layer and the amounts thereof are determined (selection of the kinds of PVA and the lamellar inorganic compound(s) used, and use or disuse of other additives) according to desired fogging property, adhesion, and scratch resistance of the protective layer as well as desired oxygen-blocking property and removability during development. Generally, the higher the hydrolysis rate of PVA is (the higher the content of unsubstituted vinyl alcohol units in the protective layer is), the higher the oxygen-blocking property is. Alternatively, the larger the film thickness is, the higher the oxygen-blocking property is. A high oxygen-blocking property is advantageous to sensitivity. However, excessively increased oxygen-blocking property may cause undesirable polymerization reaction during production or storage of planographic printing plate precursors, or may result in undesirable fogging, and thickening of image lines during image exposure. In addition, the adhesion between the image portions of the image-recording layer and the protective layer and scratch resistance of the protective layer are very important in handling printing plates or precursors thereof. In this regard, when a hydrophilic layer of a water-soluble polymer is provided on an oleophilic image-recording layer, these layers insufficiently adhere to each other, and the protective layer easily separates from the image-recording layer, and oxygen enters at the portions of the image-recording layer which are not covered by the protective layer and inhibits polymerization, resulting in defects such as insufficient hardening of the portions. In order to address such problems, various methods for improving the adhesion between these two layers were proposed. For example, it was disclosed in U.S. patent application Ser. Nos. 292,501 and 44,563 that a hydrophilic layer having strong adhesion with respect to an image-recording layer can be prepared by mixing 20 to 60% by mass of an acrylic emulsion or a water-insoluble vinylpyrrolidone-vinyl acetate copolymer with a hydrophilic polymer or polymers mainly containing polyvinyl alcohol and coating the resulting composition onto the image-recording layer.

Any of these known methods may be used in preparing the protective layer in the invention to such an extent that such a method does not impair the advantages of inclusion of the lamellar inorganic compound.

Alternatively, polyvinyl alcohol and polyvinylpyrrolidone may be used as the binders of the protective layer in the invention so as to improve the adhesive strength of the protective layer to the image-recording layer and sensitivity and so as to prevent undesirable fogging. The mass ratio of polyvinyl alcohol to polyvinylpyrrolidone is preferably 3/1 or less.

Preparation of Protective Layer Containing Lamellar Inorganic Compound

A protective layer containing a lamellar inorganic compound in the invention is formed by preparing a dispersion liquid of a lamellar inorganic compound, blending the dispersion liquid and at least one of the binder components described above (or the aqueous solution of the binder component) to prepare a coating solution for a protective layer, and applying the coating solution for a protective layer to an image-recording layer.

First, an ordinary method of dispersing the lamellar inorganic compound for use in the protective layer will be described. First, 5 to 10 parts by mass of a swelling mica compound, one of the preferable lamellar inorganic compounds described above, is added to 100 parts by mass of water, and allowed to mix with water and to swell, and the resultant mixture is stirred with a dispersing machine. The dispersing machine can be a mill that directly applies mechanical force to the content so as to stir the content, a high-speed agitating dispersing machine having great shearing force, and/or a dispersing machine applying high intensity ultrasonic waves to the content. Typical examples thereof include a ball mill, a sand grinder mill, a visco mill, a colloid mill, a homogenizer, a dissolver, a polytron, a homomixer, a homoblender, a Keddy mill, a jet agitator, a capillary emulsifying device, a liquid siren, an electromagnetic distortion ultrasonic wave generator, and an emulsifying device having a Pallmann whistle. The dispersion of the mica compound prepared by the above method and having a concentration of 2 to 15% by mass is highly viscous or gel, and has extremely good storage stability.

Preferably, the dispersion is diluted with water, and the resultant mixture is stirred sufficiently and mixed with a binder component (or the aqueous solution of a binder component) in preparing a coating solution for a protective layer.

The coating solution for a protective layer may contain at least one of known additives such as a surfactant for improving coating efficiency and a water-soluble plasticizer for improving the physical properties of a film. Examples of the water-soluble plasticizer include propionamide, cyclohexanediol, glycerol, and sorbitol. Alternatively, the water-soluble plasticizer may be a water-soluble (meth)acrylic polymer. Further, the coating solution may contain at least one of known additives for improving the adhesion between the image-recording layer and the protective layer and storability of the coating solution.

A method for forming the protective layer in the invention is not particularly limited, and may be one of the methods described in U.S. Pat. No. 3,458,311 and JP-A No. 55-49729.

The coating amount of the protective layer in the invention is generally 0.5 to 2.0 g/m², and preferably 0.75 to 1.0 g/m². When the coating amount is less than 0.5 g/m², the resultant protective layer cannot maintain sufficient strength and scratch resistance thereof deteriorates. When the coating amount is more than 2.0 g/m², the incident light entering the protective layer during light exposure scatters, resulting in deteriorated images.

Support

Any of known supports used in planographic printing plate precursors may be used as the support in the invention.

The support is preferably a plate-shaped one having dimensional stability. Examples thereof include paper; paper on which a plastic resin (e.g., polyethylene, polypropylene, or polystyrene.) layer is laminated; metal plates (e.g., aluminum, zinc, and copper plates); plastic films (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinyl acetal films); paper and plastic films on which any of the metals described above is laminated or vapor-deposited. The surface of the support may be physically or chemically processed by a known method in order to impart hydrophilicity to the support and to improve the strength of the support if necessary.

The support is preferably paper, a polyester film, or an aluminum plate, and more preferably an aluminum plate, which is superior in dimensional stability and relatively cheap, and whose surface can be provided with superior hydrophilicity and strength due to surface treatment, which is carried out according to need. In addition, the support is also preferably a composite sheet in which an aluminum sheet is laminated on a polyethylene terephthalate film, such as those disclosed in JP-B No. 48-18327.

The aluminum plate as the support most preferably used in the invention is a metal plate containing aluminum, which has dimensional stability, as the main component thereof. Examples thereof include a pure aluminum plate, an alloy plate containing aluminum as the main component and a trace amount of at least one element other than aluminum, and plastic films and paper on which aluminum or an aluminum alloy is laminated or vapor-deposited. In the description below, both a support made of aluminum and that made of the aluminum alloy described above are called aluminum supports examples of the element(s) other than aluminum which may be contained in the aluminum alloy include silicon, iron, manganese, copper, magnesium, chromium, zinc, bismuth, nickel, and titanium. The content of such an element or elements in the alloy is 10% by mass or less. The support in the invention is most preferably a pure aluminum support. However, it is difficult to prepare completely pure aluminum because of problems regarding a purifying process. Therefore, the aluminum plate may contain a trace amount of at least one element other than aluminum. As described above, the composition of the aluminum plate to be used in the invention is not particularly limited, and any of aluminum plates which are known and used in the an, for example, those satisfying requirements stipulated in JIS A 1050, A1100, A3103, and/or A3005, may be appropriately used.

The thickness of the aluminum support for use in the invention is about 0.1 mm to about 0.6 mm. The thickness may be suitably changed according to the size of a printer, the dimension of a desired printing plate, and needs by users.

The surface of the aluminum support used in the invention may be subjected to treatment described later, if necessary.

Surface Roughening Treatment

The surface of the aluminum support may be roughened. Examples of a method for roughening the surface include mechanical surface roughening, chemical etching and electrolytic graining disclosed in JP-A No. 56-28893; an electrochemical surface roughening method of electrochemically roughening the surface in a hydrochloric acid or nitric acid electrolyte; and mechanical surface roughening methods such as a wire brush graining method of scratching an aluminum surface with a metal wire, a ball graining method of roughening an aluminum surface with polishing balls and an abrasive, a brush graining method of roughening a surface with a nylon brush and an abrasive. One of these roughening methods or a combination of two or more of them can be conducted. The surface roughening method is preferably an electrochemical method of chemically roughening an aluminum surface in a hydrochloric or nitric acid electrolyte. The suitable amount of electricity is in the range of 50 to 400 C/dm², when the support serves as an anode. More specifically, alternate and/or direct current electrolysis is preferably carried out in an electrolyte having a hydrochloric or nitric acid content of 0.1 to 50% at a temperature in the range of 20 to 80° C. at an electric current density of 100 to 400 C/dm² for a period in the range of one second to 30 minutes.

The aluminum support whose surface has been roughened may be chemically etched in an acid or alkaline solution. Typical examples of an etching agent include sodium hydroxide, sodium carbonate, sodium aluminate, sodium metasilicate, sodium phosphate, potassium hydroxide, and lithium hydroxide. The concentration and the temperature of the etching agent are preferably 1 to 50%, and 20 to 100° C., respectively. In order to remove stains remaining on the etched surface (smuts), the support is washed with acid. Typical examples of the acid include nitric acid, sulfuric acid, phosphoric acid, chromic acid, hydrofluoric acid, and borofluoric acid. A method for removing smuts on the surface electrochemically roughened is preferably a method described in JP-A No. 53-12739 in which the surface is brought into contact with 15 to 65% by mass of sulfuric acid at a temperature in the range of 50 to 90° C., and/or a method described in JP-B 48-28123 in which the surface is etched with alkali. The method and conditions are not particularly limited, as long as the surface roughness Ra of the roughened surface is about 0.2 to about 0.5 μm.

Anodizing Treatment

The aluminum support which has been treated in the above manner and has an oxide layer thereon is then anodized.

In the anodizing treatment, one or more of aqueous solutions of sulfuric acid, phosphoric acid, and oxalic acid, and boric acid and sodium borate arc used as the main component of an electrolytic solution. The electrolyte solution may contain other components commonly contained in aluminum alloy plates, electrodes, tap water, and underground water. The electrolyte solution may also contain a second component and may -further contain a third component Examples of the second and third components include cations such as metal ions such as Na, K, Mg, Li, Ca, Ti, Al, V, Cr, Mn, Fe, Co, Ni, Cu, and Zn ions and an ammonium ion; and anions such as nitrate, carbonate, chloride, phosphate, fluoride, sulfite, titanate, silicate, and borate ions. The concentration of the second and third elements is preferably about 0 to 10,000 ppm. Although the conditions of the anodizing treatment are not particularly limited, the treatment is preferably performed by direct or alternating current electrolysis at a content of an acid commonly used as the main component of the electrolyte solution of 30 to 500 g/liter, at an electrolyte solution temperature of 10 to 70° C. and at an electric current density in the range of 0.1 to 40 A/m². The thickness of the resultant anodic oxidation film is generally in the range of 0.5 to 1.5 μm, and preferably in the range of 0.5 to 1.0 μm The conditions of the treatment are preferably selected such that the anodic oxidation film formed on the treated support has micropores having a size of 5 to 10 nm and a pore density of 8×10¹⁵ to 2×10¹⁶ pores/m².

A treatment for imparting hydrophilicity to the surface of the support can be any of well known methods. A treatment for imparting hydrophilicity with silicate or polyvinylphosphonic acid is particularly preferably conducted. A film in which the amount of a silicon or phosphorus element is 2 to 40 mg/m² and preferably 4 to 30 mg/m² is formed on the surface of the support. The coated amount may be measured by a fluorescent X-ray analysis method.

The treatment for imparting hydrophilicity is performed, for example, by immersing the aluminum support having thereon an anodic oxidation film in an aqueous solution containing 1 to 30% by mass, preferably 2 to 15% by mass of alklaline metal silicate or polyvinylphosphonic acid having, at 25° C., a pH of 10 to 13 and kept at a temperature in the range of 15 to 80° C. for 0.5 to 120 seconds.

The alkali metal silicate salt used in the hydrophilicity-imparting treatment can be sodium silicate, potassium silicate, and/or lithium silicate. Hydroxide can be used to raise the pH of the solution of the alkali metal silicate salt, and examples thereof include sodium hydroxide, potassium hydroxide, and lithium hydroxide. At least one of alkaline earth metal salts and salts including a metal of Group IVB may be added to the treatment solution. Examples of the alkaline earth metal salts include water-soluble salts including nitrates such as calcium nitrate, strontium nitrate, magnesium nitrate, and barium nitrate, sulfates, hydrochlorides, phosphates, acetates, oxalates, and borates. Examples of the salts including a metal of Group IVB include titanium tetrachloride, titanium trichloride, titanium potassium fluoride, titanium potassium oxalate, titanium sulfate, titanium tetraidodide, zirconium oxychloride, zirconium dioxide, zirconium oxychloride, and zirconium tetrachloride.

One of the alkaline earth metal salts and the salts each including a metal of Group IVB may be used alone or two or more of them can be used together. The content of the metal salt(s) is preferably 0.01 to 10% by mass, and more preferably 0.05 to 5.0% by mass. Moreover, silicate electrodeposition as described in U.S. Pat. No. 3,658,662 is also effective. Surface treatment in which a support electrolytically grained as disclosed in JP-B No. 46-27481, JP-A No. 52-58602 or 52-30503, and the aforementioned anodizing treatment and treatment for imparting hydrophilicity are combined with each other is also useful.

<Preparation of Planographic Printing Plate Precursor>

The planographic printing plate precursor of the invention has an image-recording layer and a protective layer on a support in that order and may have an undercoat layer, if necessary. The planographic printing plate precursor is prepared by dissolving the above-described components in a suitable solvent or solvents and sequentially applying the resulting coating solutions to a support.

The image-recording layer is formed by dissolving the above-described components of the image-recording layer in at least one organic solvents and applying the resultant image-recording layer coating solution to a support or an undercoat layer.

Examples of the solvent(s) include acetone, methyl ethyl ketone, cyclohexane, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetylacetone, cyclohexanone, diacetone alcohol, ethylene glycol monoethyl ether acetate, ethylene glycol ethyl ether acetate, ethylene glycol monoisopropyl ether acetate, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethylsulfoxide, γ-butylolactone, methyl lactate, and ethyl lactate. One of these solvents may be used alone or two or more of them can be used together. The concentration of the solid matters in the image-recording layer coating solution is preferably 2 to 50% by mass.

It is preferable to appropriately determine a desired coating amount of the image-recording layer, which can mainly influence the sensitivity and the developing property of the image-recording layer, and the strength and the printing durability of the exposed layer, according to the application of the precursors. When the coating amount is too small, the resultant precursor has insufficient printing durability. On the other hand, when It is too large, the resultant precursor has decreased sensitivity, and consequently exposure of the precursor to light requires much time, and development of the exposed plate needs longer time. When the planographic printing plate precursor of the invention is to be exposed to light by scanning it with an infrared ray, the dry amount of the image-recording layer is preferably in the range of about 0.1 to about 10 g/m², and more preferably in the range of 0.5 to 5 g/m².

Physical Properties of Image-Recording Layer

As for the physical properties of the image-recording layer in the invention, the non-exposed regions preferably have a developing speed of 80 nm/sec or more in an alkaline developing solution having a pH of 10 to 13.5, and the penetration speed of the alkaline developing solution into the exposed regions is preferably 50 nF/sec or less.

The developing speed of the non-exposed regions in the alkaline developing solution having a pH of 10 to 13.5 is calculated by dividing the (initial) thickness (nm) of the image-recording layer by the time necessary to develop the image-recording layer, and the penetration speed of the alkaline developing solution into the exposed regions shows the speed of change in electrostatic capacity (nF) of the image-recording layer which is formed on an electrically conductive support and is being immersed in the developing solution.

Hereinafter, a method for measuring the developing speed of the non-exposed regions in the alkaline developing solution and a method for measuring the “penetration speed of the alkaline developing solution into the exposed regions” in the invention will be described in detail.

Measurement of Developing Speed of Exposed Regions in Alkaline Developing Solution

As described above, the developing speed of the non-exposed regions in the alkaline developing solution is obtained by dividing the thickness (nm) of the image-recording layer by the time necessary to develop the image-recording layer (second).

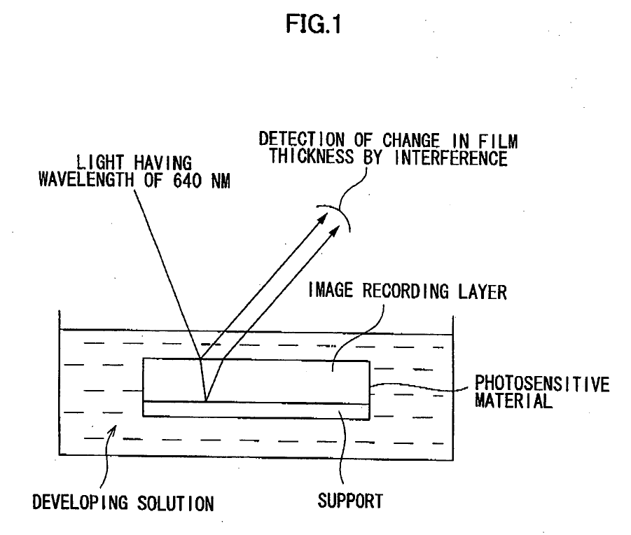

In measuring the developing speed, a non-exposed image-recording layer formed on an aluminum support is immersed in an alkaline developing solution having a constant pH in the range of 10 to 13.5 and kept at 30° C., and the dissolving behavior of the image-recording layer is observed with a DRM interference wave-measuring instrument. FIG. 1 is a schematic view of the DRM interference wave-measuring instrument used to study the dissolving behavior of the image-recording layer. In the invention, a change in film thickness is detected by utilizing interference caused by light having a wavelength of 640 nm. When development does not cause swelling of the image-recording layer and dissolution of the image-recording layer starts with dissolution of the surface thereof, the layer gradually thins with the passage of developing time, and the interference wave corresponding to a film thickness is obtained. Alternatively, when development causes swelling of the image-recording layer and the swollen layer separates from the support in the form of masses, penetration of the developing solution into the layer causes the layer to thicken due to swelling thereof and thin due to separation thereof from the support, and thus a distinct interference wave cannot be obtained.

Measurement is continued under these conditions until the image-recording layer is completely removed. The developing speed is obtained according to the following equation on the basis of a time necessary to completely remove the image-recording layer and to thereby decrease the layer thickness to 0 (development completion time) (second) and the initial thickness of the image-recording layer (nm). A high developing speed means that the layer is readily removed with the developing solution and that the developing property of the layer is good.
Developing speed (of non-exposed regions)=Initial thickness of image-recording layer (nm)/Development completion time (second)
Measurement of Permeation Speed of Alkaline Developing Solution into Exposed Regions

As described above, the permeation speed of the alkaline developing solution into the exposed regions refers to the speed of change in electrostatic capacitance (nF) of the image-recording layer which is formed on an electrically conductive support and is being Immersed in the developing solution.

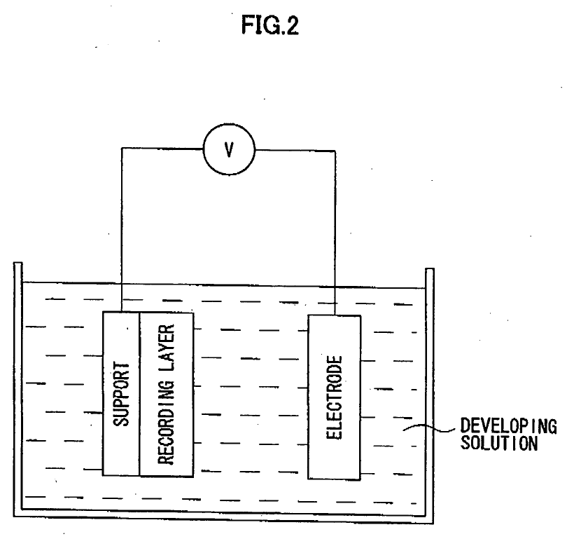

In order to measure electrostatic capacity, the following method can be conducted. As shown in FIG. 2, an aluminum support having thereon an image-recording layer is exposed to light at a predetermined light exposure, and the support, whose image-recording layer has been cured and which serves as an electrode, is then immersed in an alkaline developing solution having a pH in the range of 10 to 13.5 and kept at 28° C. A conventional electrode serving as a counter electrode is also immersed in the alkaline developing solution and wires or cables are electrically connected to the support and the aluminum support, respectively. Then, an electrical voltage is applied to the resultant circuit. After the application is started, the developing solution penetrates into the image-recording layer with the passage of time, and then reaches the interface between the support and the image-recording layer. During this process, the electrostatic capacity of image-recording layer changes.

The penetration speed can be obtained according to the following equation on the basis of a time from a time when the measurement has just started to a time when electrostatic capacity no longer changes (second) and the saturated electrostatic capacity of the image-recording layer (nF). The lower the penetration speed is, the lower the penetrating property of the developing solution is.
Penetration speed of developing solution into exposed regions=Saturated electrostatic capacity of image-recording layer (nF)/time described above (sec)

As for the physical properties of the image-recording layer of the planographic printing plate precursor of the invention, the developing speed of the non-exposed regions in the alkaline developing solution having a pH of 10 to 13.5 which developing speed is determined in the above manner is more preferably 80 to 400 nm/second and still more preferably 90 to 200 nm/second. On the other hand, the penetration speed of the alkaline developing solution into exposed regions is more preferably 0 to 50 nF/second and still more preferably 0 to 10 nF/second.

Any of methods commonly practiced in the art may be conducted to control the developing speed of the non-exposed regions of the image-recording layer and the penetration speed of the alkaline developing solution into the cured regions or the exposed regions of the image-recording layer. For example, in order to accelerate the developing speed of the non-exposed regions, it is effective that the image-recording layer contains a hydrophilic compound. Moreover, in order to suppress the penetration of the developing solution into the exposed regions, it is effective that the image-recording layer contains a hydrophobic compound.

In the invention, each of the developing speed of the image-recording layer and the penetration speed of the developing solution can be easily adjusted at a value within the above-described, preferable range by using the aforementioned specific binder polymer.

Intermediate Layer (Undercoat layer)

The planographic printing plate precursor of the invention may have an intermediate layer (also referred to as an undercoat layer) for the purpose of improving the adhesion between the image-recording layer and the support and the staining property of the precursor. Specific examples of such an intermediate layer include those described in JP-B No. 50-7481, JP-A Nos. 54-72104, 59-101651, 60-149491, 60-232998, 3-56177, 4-282637, 5-16558, 5-246171, 7-159983, 7-314937, 8-202025, 8-320551, 9-34104, 9-236911, 9-269593, 10-69092, 10-115931, 10-161317, 10-260536, 10-282682 and 11-84674, and Japanese Patent Application Nos. 8-225335, 8-270098, 9-195863, 9-195864, 9-89646, 9-106068, 9-183834, 9-264311, 9-127232, 9-245419, 10-127602, 10-170202, 11-36377, 11-165861, 11-284091 and 2000-14697.

<Printing Plate-Making Method>

Hereinafter, a method for making a planographic printing plate from the planographic printing plate precursor of the invention will be described.

In the printing plate-making method, preferably, the planographic printing plate precursor of the invention is exposed to light having a wavelength of 750 to 1400 nm and the exposed, half-finished planographic printing plate is then developed without substantial heating. More preferably, after light exposure processing, the exposed, half-finished planographic printing plate is developed without substantially heating and washing with water. In the invention, the conveying speed of the exposed, half-finished planographic printing plate during development is preferably 1.25 m/minute or more.

The image-recording layer of the planographic printing plate precursor from which a printing plate is obtained in accordance with the printing plate-making method preferably has the following physical properties. That is, the developing speed of the non-exposed regions in the alkaline developing solution having a pH of 10 to 1 3.5 is 30 nm/sec or more, and the penetration speed of the alkaline developing solution into the exposed regions is 50 nF/sec or less. The adjusting methods of the developing speed of the non-exposed regions of the image-recording layer and the penetration speed of the alkaline developing solution into the cured regions of the image-recording layer have been aforementioned.

Light Exposure

The light source for use in the exposure in the invention needs to be able to emit light having a wavelength of 750 to 1,400 nm, and otherwise it is not limited. However, the light source is preferably an Infrared laser, and more preferably a solid-state or semiconductor laser which can emit infrared light having a wavelength of 750 to 1,400 nm. The laser preferably has a power of 100 mW or more. The light source is preferably a multi beam laser device to shorten the exposure time. The exposure time per pixel is preferably 20 μsec or less. The energy of light with which the planographic printing plate precursor is irradiated is preferably 10 to 300 mJ/cm². When the light exposure energy is too low, the image-recording layer is insufficiently cured. When the light exposure energy is too high, the laser may cause ablation of the image-recording layer and a damaged image may be obtained.

In the exposure, the light source can emit light beams so that the light beams overlap with each other on the image-recording layer. The phrase “light beams overlap with each other” means that the sub scanning pitch is smaller than the diameter of the light beams. When the beam diameter is expressed by the half breadth of the beam intensity (FWHM), the degree of overlap can be quantitatively expressed by FWHM/sub scanning pitch (overlap coefficient). In the invention, the overlap coefficient is preferably 0.1 or higher.

The scanning method of the light source of an exposure device for use in the invention is not particularly limited, and the exposure may be performed by scanning laser beams on the printing plate precursor fixed on the external or internal surface of a cylindrical drum, or on the printing plate precursor levelly disposed. The light source may have a single channel or multi channels. When laser beams are scanned on the printing plate precursor fixed on the external surface of a cylindrical drum, the light source preferably has multi channels.

In the invention, the exposed, half-finished planographic printing plate is preferably developed without heating and washing with water, as described above. Absence of heating can prevent non-uniformity of images caused by heating. In addition, absence of heating and washing with water enables stable, high-speed development.

Development

In the invention, the non-image regions of the image-recording layer are removed with a developing solution during development.

In the invention, the processing speed during development, or the conveying speed (line speed) of the exposed, half-finished planographic printing plate during development is preferably 1.25 m/min or more, and more preferably 1.35 m/min or more, as described above. The upper limit of the conveying speed is not particularly limited, but, from the viewpoint of stability of conveyance, is preferably 3 m/min or less.

Hereinafter, the developing solution for use in the invention will be described below.

Developing Solution

The developing solution for use in the invention is preferably an aqueous alkaline solution having a pH of 14 or lower, and more preferably an aqueous alkaline solution containing at least one anti-gelling agent selected from the group consisting of monoalcohol and monoketone compounds, and at least one anionic surfactant.

Monoalcohol and Monoketone Compounds

The monoalcohol and monoketone compounds containable in the developing solution for use in the invention are monofunctional compounds having at least one alcohol or ketone unit in the molecule thereof. The monoalcohol and monoketone compounds in the invention preferably have a high boiling point because such compounds are unlikely to evaporate and can maintain their effects for a long period of time. Use of such a compound is effective in preventing gelation of the water-soluble polymer derived from the protective layer and dissolved in the developing solution.

Usually, gelation in a developing solution deteriorates the developing property of the developing solution and results in staining in non-image regions, and the gel in the developing solution clogs pipes and spray tubes. In order to address these problems, it is necessary that the developing solution be replaced to remove the gel. This decreases operational efficiency. However, because the monoalcohol or monoketone compound prevents gelation for a long period of time, the compound can also prevent staining in non-image regions, decrease the frequency of replacement of the developing solution and prevent decrease in operational efficiency.

Typical examples of the monoalcohol and monoketone compounds include n-propyl alcohol, iso-propyl alcohol, n-butyl alcohol, iso-butyl alcohol, secondary-butyl alcohol, tertiary-butyl alcohol, n-amyl alcohol, secondary-amyl alcohol, tertiary-amyl alcohol, cyclohexanol and derivatives thereof, phenoxyethanol and derivatives thereof, phenol and derivatives thereof, diethyl ketone, and cyclohexanone and derivatives thereof.

One of these compounds may be used alone or two or more of them can be used together. The content of the monoalcohol compound and/or the monoketone compound in the developing solution is preferably 0.01 to 10% by mass, more preferably 1 to 8% by mass, and still more preferably 2 to 8% by mass.

The developing solution for use in the invention preferably contains at least one aromatic anionic surfactant in addition to the monoalcohol and/or monoketone compound.

Aromatic Anionic Surfactant

An aromatic anionic surfactant for use in the developing solution is effective in accelerating development and stabilizing dispersion of the components contained in the negative-type polymerizable image-recording layer and the protective layer in the developing solution, and is thus preferably contained so as to stabilize the development The aromatic anionic surfactant is preferably a compound represented by the following Formula (a) or (b).

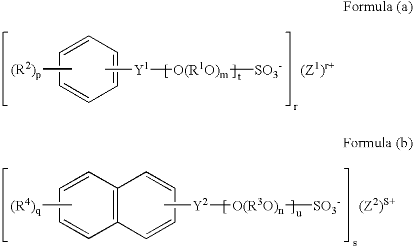

In Formulas (a) and (b), each of R¹ and R³ represents a linear or branched alkylene group having 1 to 5 carbon atoms, and is, for example, an ethylene, propylene, butylene, or pentylene group, and is preferably an ethylene or propylene group. Each of m and n represents an integer of 1 to 100, and is preferably 1 to 30, and still more preferably 2 to 20. When m is 2 or more, R¹ groups may be the same as or different from each other. When n is 2 or more, R³ groups may be the same as or different from each other.

Each of t and u represents 0 or 1.

Each of R² and R⁴ represents a linear or branched alkyl group having 1 to 20 carbons, and is, for example, a methyl, ethyl, propyl, butyl, hexyl, or dodecyl group, and is preferably a methyl, ethyl, isopropyl, n-propyl, n-butyl, iso-butyl, or tert-butyl group.

Each of p and q is an integer of 0 to 2. Each of Y¹ and Y² represents a single bond or an alkylene group having 1 to 10 carbon atoms, and is preferably a single bond or a methylene or ethylene group, and is more preferably a single bond.

Each of (Z¹)^{r+} and (Z²)^{x+} represents an alkali metal ion, an alkaline earth metal ion, or an unsubstituted or alkyl-substituted ammonium ion. Typical examples thereof include lithium, sodium, potassium, magnesium, calcium, and ammonium ions, and secondary to quaternary ammonium ions substituted with at least two of alkyl groups having 1 to 20 carbons, aryl groups, and aralkyl groups. Each of (Z¹)^{r+} and (Z²)^{s+} is preferably a sodium ion. Each of r and s is 1 or 2.

Hereinafter, specific examples thereof are shown below, however the invention is not limited by these examples.

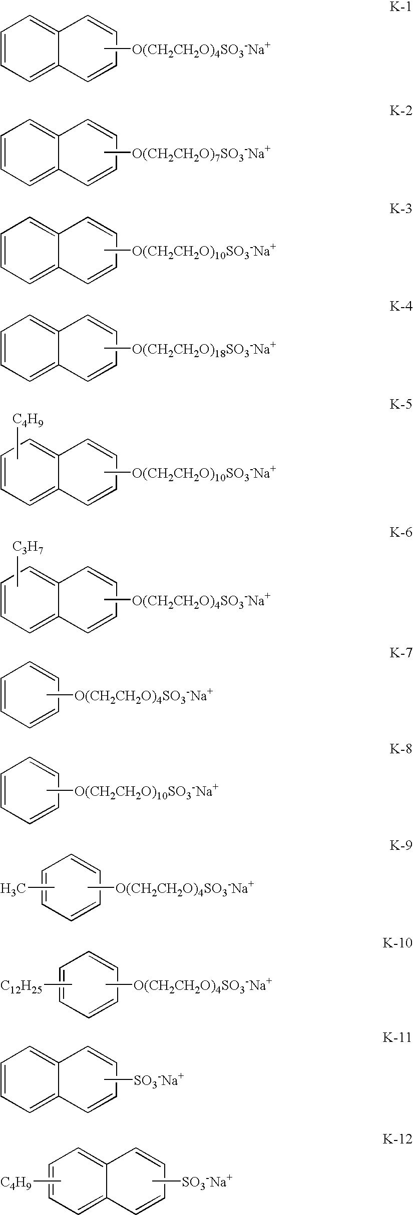

One of these aromatic anionic surfactants may be used alone or two or more of them can be used together. The concentration of the aromatic anionic surfactant(s) in the developing solution is preferably in the range of 1.0 to 10% by mass and more preferably in the range of 2 to 10% by mass. When the concentration is less than 1.0% by mass, such a developing solution has a deteriorated developing property and a deteriorated ability to dissolve the image-recording layer components. When the concentration is more than 10% by mass, such a developing solution deteriorates the printing durability. of printing plates.

The developing solution used in the invention may also contain at least one other surfactant in addition to the aromatic anionic surfactant(s). Other surfactants can be nonionic surfactants. Examples thereof include polyoxyethylene alkyl ethers such as polyoxyethylene naphthyl ether, polyoxyethylene alkyl phenyl ethers, polyoxyethylene lauryl ether, polyoxyethylene cetyl ether, and polyoxyethylene stearyl ether, polyoxyethylene alkyl esters such as polyoxyethylene stearate; sorbitan alkyl esters such as sorbitan monolaurate, sorbitan monostearate, sorbitan distearate, sorbitan monooleate, sorbitan sesquioleate, and sorbitan trioleate; and monoglyceride alkyl esters such as glycerol monostearate and glycerol monooleate.

The content of other surfactant(s) in the developing solution is preferably 0.1 to 10% by mass when calculated on the basis of the active components.

Chelating Agent for Bivalent Metal

The developing solution used in the invention preferably contains at least one chelating agent for bivalent metal(s) so as to, for example, suppress the adverse effects of the bivalent metals such as calcium ions contained in hard water. Examples of the chelating agent for bivalent metal(s) include polyphosphates such as Na₂P₂O₇, Na₅P₃O₃, Na₃P₃O₉, Na₂O₄P(NaO₃P)PO₃Na₂, Calgon (sodium polymetaphosphate); amino-polycarboxylic acids such as ethylenediamine tetraacetic acid and potassium, sodium, and amine salts thereof, diethylenetriamine pentaacetic acid and potassium and sodium salts thereof, triethylenetetramine hexaacetic acid and potassium and sodium salts thereof, hydroxyethylethylenediamine triacetic acid and potassium and sodium salts thereof, nitrilotriacetic acid and potassium and sodium salts thereof, 1,2-diaminocyclohexane tetraacetic acid and potassium and sodium salts thereof, and 1,3diamino-2-propanol tetraacetic acid and potassium and sodium salts thereof; and organic phosphonic acids such as 2-phosphonobutane tricarboxylic acid-1,2,4 and potassium and sodium salts thereof; 2-phosphonobutanone tricarboxylic acid-2,3,4 and potassium and sodium salts thereof; 1-phosphonoethane tricarboxylic acid-1,2,2 and potassium and sodium salts thereof, 1-hydroxyethane-1,1-diphosphonic acid and potassium and sodium salts thereof, and aminotri(methylenephosphonic acid) and potassium and sodium salts thereof. The chelating agent for bivalent metal(s) is preferably ethylenediamine tetraacetic acid or a potassium, sodium, or amine salt thereof, ethylenediamine tetra(methylenephosphonic acid) or an ammonium or potassium salt thereof, or hexamethylenediamine tetra(methylenephosphonic acid) or an ammonium or potassium salt thereof.

The optimum content of the chelating agent used depends on the hardness and the amount of hard water used. However, the content of the chelating agent(s) in the developing solution is generally in the range of 0.01 to 5% by mass and preferably 0.01 to 0.5% by mass.

The developing solution used in the invention may contain at least one of alkali metal salts of organic and inorganic acids as a development control agent. For example, one or a combination of two or more selected from sodium carbonate, potassium carbonate, ammonium carbonate, sodium citrate, potassium citrate, and ammonium citrate may be contained in the developing solution.

Alkali Agent

The developing solution used in the invention may contain at least one alkali agent. Examples thereof include inorganic alkali agents such as trisodium phosphate, tripotassium phosphate, triammonium phosphate, sodium borate, potassium borate, ammonium borate, sodium hydroxide, potassium hydroxide, ammonium hydroxide, and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, pyridine, and tetramethylammonium hydroxide. In the invention, one of these alkali agents may be used alone or two or more of them can be used together.

In addition to the above compounds, the alkali agent can be an alkali silicate. The alkali silicate may be used in combination with at least one base. The alkali silicate salt is a salt which is dissolved in water to form an alkaline solution, and examples thereof include sodium silicate, potassium silicate, lithium silicate, and ammonium silicate. One of these alkali silicates may be used alone or two or more of them can be used together.

The developing solution for use in the invention can be optimally adjusted by controlling the mixing ratio and the concentrations of silicon oxide SiO₂, a component of the silicate salt used as a hydrophilicity-imparting component for a supports and an alkali oxide M₂O (M represents an alkali metal or an ammonium group) used as an alkali component. The mixing ratio (molar ratio) of silicon oxide SiO₂ to alkali oxide M₂O (SiO₂/M₂O) is preferably in the range of 0.75 to 4.0, and more preferably in the range of 0.75 to 3.5 for the purpose of suppressing stains caused by leaving a support in the developing solution for a too long period of time and by excessively dissolving (etching) the anodic oxide film on the support in the solution, or suppressing generation of insoluble gases caused by the dissolved aluminum and silicate forming a complex.

From the viewpoints of suppression of the dissolution (etching) of the anodic oxide film disposed on the support, the developing property of the developing solution, suppression of precipitation and crystal growth, and suppression of the gelation of the alkaline silicate caused by neutralization of wastewater, the concentration of the alkali silicate(s) in the developing solution is such that the content of silicon dioxide in the developing solution is preferably in the range of 0.01 to 1 mol/L and more preferably in the range of 0.05 to 0.8 mol/L.

The developing solution used in the invention may further contain at least one of the following components in addition to the components described above, if necessary. Examples thereof include organic carboxylic acids such as benzoic acid, phthalic acid, p-ethylbenzoic acid, p-n-propylbenzoic acid, p-iso-propylbenzoic acid, p-n-butylbenzoic acid, p-t-butylbenzoic acid, p-2-hydroxyethylbenzoic acid, decanoic acid, salicyclic acid, and 3-hydroxy-2-naphthoic acid; organic solvents such as propylene glycol; and reducing agents, dyes, pigments, softeners for hard water, and antiseptics.

The pH of the developing solution for use in the invention is preferably in the range of 10 to 12.5 and more preferably in the range of 11 to 12.5 at 25° C. Even when the developing solution used in the invention has such a low pH, the developing solution contains the surfactant(s) described above, and, therefore, exhibits an excellent developing property with respect to the non-image regions of plates. Adjusting the phi of the developing solution to a relatively low value can lessen damage on image regions during development and facilitate handling of the developing solution.

The electric conductivity x of the developing solution is preferably 2 to 30 mS/cm and more preferably 5 to 25 mS/cm.

Here, It is preferable that the developing solution contains at least one of alkali metal salts of organic and inorganic acids as an agent for adjusting the electric conductivity of the developing solution.

The developing solution can also be used as a development replenisher for exposed, half-finished planographic printing plates, and is preferably used in automatic developing machines. When the printing plates are developed in an automatic developing machine, the developing solution deteriorates with increase in the total number of processed printing plates. Therefore, processing efficiency may be recovered by adding a replenishing solution or a fresh developing solution. The replenishment is preferably conducted in the printing plate-making method in the invention.

Use of the replenishing method described in U.S. Pat. No. 4,882,246 is also preferred to recover the processing efficiency of the developing solution in an automatic developing machine. The developing solution used is also preferably any of the developing solutions described in JP-A Nos. 50-26601 and 58-54341 and JP-B Nos. 56-39464, 56-42860, and 57-7427.

The half-finished planographic printing plate thus developed is then post-treated with washing water, a rinsing solution containing, for example, a surfactant, and/or a desensitizing solution containing gum arabic, and/or at least one starch derivative, as described in JP-A Nos. 54-8002, 55-115045, and 59-58431. Two or more of these treatments can be conducted in the post treatment of the half-finished planographic printing plate.

In the method of making a planographic printing plate in the invention, the entire surface of the image obtained by development may be post-heated and/or exposed to light for improvement in strength and printing durability of the image.

Very severe conditions may be used during the heating after development Heating is usually performed at a temperature in the range of 200 to 500° C. When the heating temperature is low, such heating cannot sufficiently enhance the strength of the image. When the heating temperature is too high, such heating may deteriorate the support and may cause thermal decomposition of the image regions.

The planographic printing plate thus obtained is then mounted on an offset printer and used to print the image thereof on numerous sheets of paper.

A plate cleaner can be used to remove stains on the printing plate during printing, and is a conventionally known plate cleaner for PS plates. Examples thereof include CL-1, CL-2, CP, CN-4, CN, CG-1, PC-1, SR, and IC (manufactured by Fuji Photo Film Co. Ltd.).

### EXAMPLES

Hereinafter, the invention will be described with reference to Examples. However, it should be understood that the invention is not restricted by these Examples.

### Example 1

[Preparation of Support]

An aluminum plate stipulated in JIS A1050 and having a thickness of 0.30 mm and a width of 1030 mm was subjected to the following surface treatment.

Surface Treatment

The surface treatment was carried out by sequentially conducting the following steps (a) to (f). After each of the steps and washing with water, liquid remaining on the aluminum plate was removed with a nip roller.

(a) The aluminum plate was etched in a solution containing 26 mass % of sodium hydroxide and 6.5 mass % of aluminium ions at 70° C., until the amount of dissolved aluminum became 5 g/m². The etched plate was then washed with water.

(b) The aluminum plate was desmutted by spraying an aqueous solution including 1 mass % of nitric acid and 0.5 mass % of aluminium ions and kept at 30° C. over the plate. The aluninum plate was then washed with water.

(c) The surface of the aluminum plate was continuously electrochemically roughened by applying an alternate current voltage having a frequency of 60 Hz to the plate immersed in an electrolyte which was an aqueous solution including 1 mass % of nitric acid, 0.5 mass % of aluminium ions and 0.007 mass %o of ammonium ions and kept at 30° C. The alternate current voltage had a trapezoidal waveform, and a time which it took to increase an electric current value from zero to the peak (TP) was 2 msec, and a duty ratio was 1:1. In the treatment, a carbon electrode was used as a counter electrode. A ferrite electrode was used as an auxiliary anode. The electric current density was 25 A/dm² at the peak of electric current. The total amount of electricity used in this treatment and used when the aluminum plate served as an anode was 250 C/cm². A part (5%) of the current supplied from a power source was applied to the auxiliary anode. The aluminum plate was then washed with water.

(d) The aluminum plate was etched by spraying a solution containing 26 mass % of sodium hydroxide and 6.5 mass % of aluminum ions over the plate at 35° C., until the amount of dissolved aluminum became 0.2 g/m². Thereby, smuts mainly including aluminum hydroxide which had occurred during the electrochemical surface roughening in which the alternate current had been used were removed, and the edge portions of pits generated were dissolved and smoothened. The aluminum plate was then washed with water.

(e) The aluminum plate was desmutted by spraying an aqueous solution including 25 mass % of sulfuric acid and 0.5 mass % of aluminum ions and kept at 60° C. over the plate. Water was sprayed on the plate to wash the plate.

(f) The aluminum plate was anodized in an electrolyte containing sulfuric acid at a concentration 170 g/L and additionally containing aluminum ions at a concentration 0.5 mass % and kept at 33° C. at an electric current density of 5 A/dm² for 50 seconds. The aluminum plate was then washed with water. After the treatment, the amount of anodic oxide film was 2.7 g/m².

Then, the surface of the aluminum plate was treated with silicate to ensure hydrophilicity of non-image regions of a printing plate to be formed.

The aluminum plate (web) was continuously fed into a 1% aqueous No. 3 sodium silicate solution kept at 70° C. and brought into contact with the solution for three seconds, and then washed with water. Thus, an aluminum support was prepared. The amount of silicon adhering to the surface of the plate was determined by fluorescent X-ray spectroscopy and found to be 3.0 mg/m². The center line surface roughness (Ra) of the support was 0.25 μm.

[Undercoat Layer]

Then, the following undercoat solution was coated onto the aluminum support with a wire bar and the resultant coating was dried with a hot air dryer at 100° C. for 10 seconds. The dry amount of the coating was determined from the carbon amount obtained by fluorescent X-ray spectroscopy and found to be 10 mg/m².

Undercoat Layer Coating Solution

| | | |
|---|---|---|
| 30% Methanol solution of a copolymer obtained by | 0.15 | g |
| copolymerizing vinylbenzoic acid and triethyl(p- | | |
| vinylbenzyl)ammonium chloride at a molar ratio of 85:15 | | |
| (number-average molecular weight of 2,100) | | |
| Methanol | 60 | g |

[Image-Recording Layer]

Subsequently, the following image-recording layer coating solution [P-1] was prepared and applied to the undercoat layer with a wire bar. The resultant was dried with a hot air dryer at 115° C. for 34 seconds. Thus, a planographic printing plate precursor was obtained. The dry coating amount of the image-recording layer was 1.3 g/m².

Image-Recording Layer Coating Solution [P-1]

| | | |
|---|---|---|
| Infrared ray absorbent (IR-1) | 0.074 | g |
| Polymerization initiator (OS-12) | 0.280 | g |
| Thiol compound (E-1) | 0.04 | g |
| Polymerizable compound (AM-1) | 1.00 | g |
| Specific binder polymer (BT-1) | 1.00 | g |
| Ethyl violet (C-1) | 0.04 | g |
| Fluorinated surfactant | 0.015 | g |
| (30 mass % solution of Magafac F-780-F manufactured | | |
| by Dainippon Ink and Chemicals, Inc. in methyl isobutyl | | |
| ketone (MIBK)) | | |

| | | |
|---|---|---|
| Methyl ethyl ketone | 10.4 | g |
| Methanol | 4.83 | g |
| 1-Methoxy-2-propanol | 10.4 | g |

The polymerization initiator (OS-12) contained in the image-recording layer coating solution is one of the exemplified compounds as the onium salt represented by Formula (1) described above. The structures of the infrared ray absorbent (IR-1), thiol compound (E-1), polymerizable compound (AM-1), specific binder polymer (BT-1), and ethyl violet (C-1) are shown below. 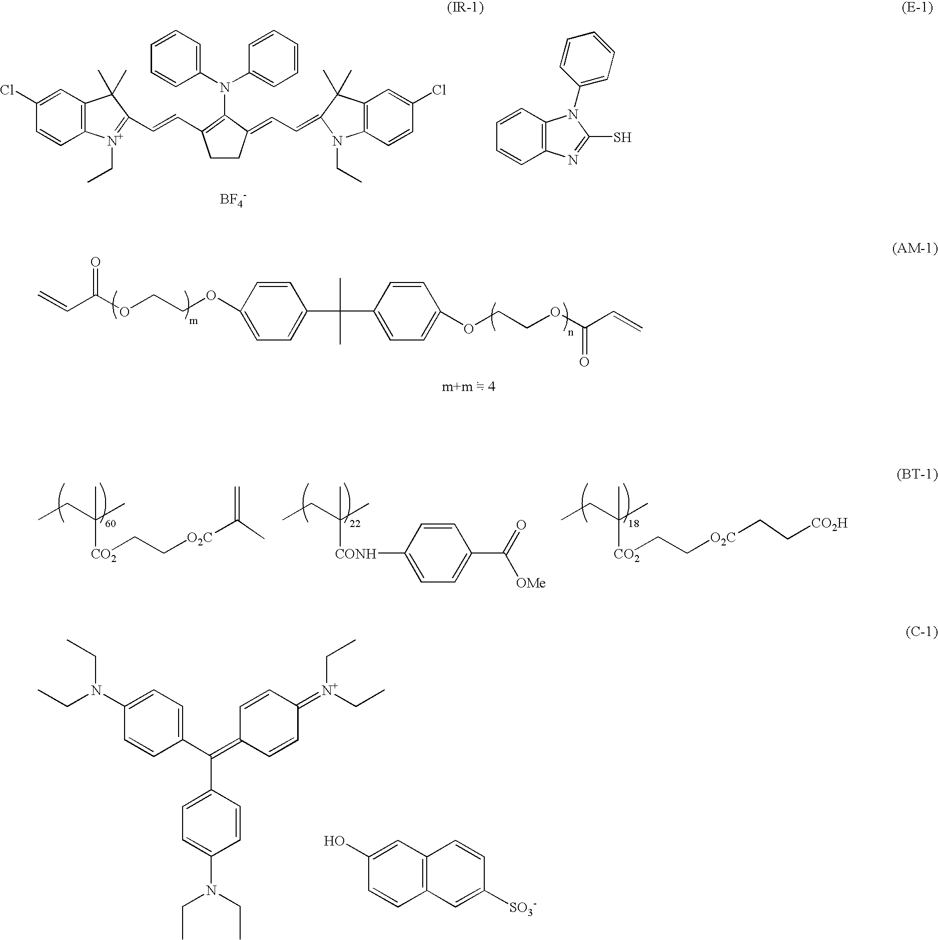
[Protective Layer]

The following water-soluble protective layer coating solution (OC-1) was coated on the surface of the image-recording layer with a wire bar and the resultant coating was dried with a hot air dryer at 125° C. for 75 seconds. The dry coating amount of the protective layer was 1.60 g/m².

Water-Soluble Protective Layer Coating Solution [OC-1]

| | | |
|---|---|---|
| Polyvinyl alcohol (saponification degree of | 40 | g |
| 88 mol %, and degree of polymerization of 500) | | |
| 6% Aqueous solution of a copolymer obtained by | 1 | g |
| copolymerizing vinylpyrrolidone and vinyl | | |
| acetate at a molar ratio of 60:40 | | |
| (LUVITEC VA64W manufactured by BASF) | | |
| 3.2% Aqueous dispersion of synthetic mica | 4.2 | g |
| (lamellar inorganic compound) (SOMASIFf MED-3L | | |
| manufactured by CO-OP Chemical Co., and having | | |
| an aspect ratio of 1,000 or more) | | |
| Surfactant (EMALEX 710 manufactured by Nippon | 1.25 | g |
| Nyukazai Co., Ltd.) | | |
| Distilled water | 50 | g |

### Examples 2 to 5

Planographic printing plate precursors of Examples 2 to 5 were prepared in the same manner as In Example 1, except that the thiol compound (E-1) in the image-recording layer coating solution was replaced respectively with the following thiol compounds (E-2) to (E-5) in an amount identical to that of the thiol compound (E-1).

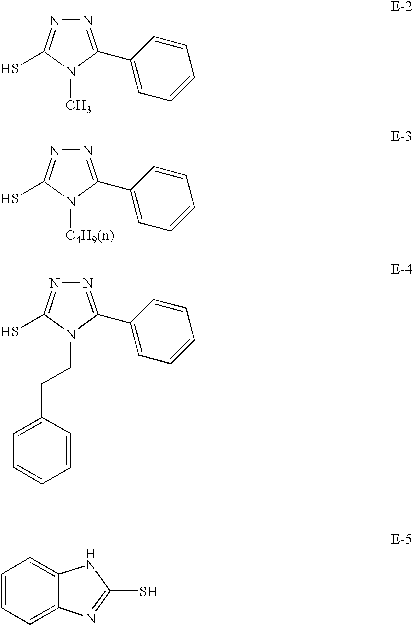

### Example 6

A planographic printing plate precursor of Example 6 was prepared in the same manner as in Example 1, except that the water-soluble protective layer coating solution [OC-1] was replaced with the following water-soluble protective layer coating solution [OC-2].

Water-Soluble Protective Layer Coating Solution [OC-2]

| | | |
|---|---|---|
| Polyvinyl alcohol (saponification degree of | 40 | g |
| 88 mol %, and degree of polymerization of 500) | | |
| 6% Aqueous solution of a copolymer obtained by | 1 | g |
| copolymerizing vinylpyrrolidone and vinyl acetate | | |
| at a molar ratio of 60:40 (LUVITEC VA64W | | |
| manufactured by BASF) | | |
| Surfactant (EMALEX 710 manufactured by Nippon | 1.25 | g |
| Nyukazai Co., Ltd.) | | |
| Distilled water | 50 | g |

### Example 7

A planographic printing plate precursor of Example 7 was prepared in the same manner as in Example 1, except that the polymerization initiator (OS-12) in the image-recording layer coating solution was replaced with a polymerization initiator (OS-13). The polymerization initiator (OS-13) is one of the exemplified compounds as the onium salt represented by Formula (1) described above.

### Comparative Example 1

A planographic printing plate precursor of Comparative Example 1 was prepared in the same manner as in Example 1, except that the image-recording layer coating solution did not include the thiol compound (E-1).

### Comparative Example 2

A planographic printing plate precursor of Comparative Example 2 was prepared in the same manner as in Example 1, except that the image-recording layer coating solution did not include the thiol compound (E-1), and except that the water-soluble protective layer coating solution [OC-1] was replaced with the water-soluble protective layer coating solution [OC-2].

[Evaluation]

Each of the thus-prepared planographic printing plate precursors was evaluated as follows.

(1) Evaluation of Sensitivity

Each of the planographic printing plate precursors was exposed to light with a TRENDSETTER QUANTUM 800II manufactured by Creo Co., Ltd. at a resolution of 1200 dpi at a rotation speed of a drum, on the external peripheral surface of which the printing plate precursor was fixed, of 200 rpm, while the power of the device was changed between 0W and 8W to change log E at intervals of 0.15. After the exposure, the plate was developed with an automatic developing machine LP-1310 NEWS manufactured by Fuji Photo Film Co., Ltd. at a conveying speed (line speed) of 2 m/minute at a developing temperature of 30° C. Nothing was placed in the first bath; the following developing solution was placed in the second bath; water was placed in the third bath; and a diluting solution including water and GN-2K manufactured by Fuji Photo Film Co., Ltd, at a ratio of 3:1 was placed in the fourth bath.

The cyan density of the image regions on the planographic printing plate obtained by the exposure and development was measured with a Macbeth reflection densitometer RD-918 and a red filter which the densitometer has. The light exposure necessary to obtain a measured density equivalent to 80% of the density before the development was used as an index for sensitivity. The smaller the value is, the higher the sensitivity of the planographic printing plate precursor is. The results are summarized in Table 1.

<Developing Solution>

The following components were dissolved in water and KOH was added to the resultant solution so as to adjust the pH of the solution at 11.95 (25° C.). Thus, a developing solution was obtained

| | | |
|---|---|---|
| NEWCOL B4SN (manufactured by Nippon | 4.0 | mass % |
| Nyukazai Co., Ltd.) | | |
| OLEFIN AK-02 (manufactured by Nisshin | 0.08 | mass % |
| Chemical Industry Co., Ltd.) | | |
| Tetrasodium ethylenediamine tetraacetate | 0.16 | mass % |
| Potassium carbonate | 0.16 | mass % |

(2) Evaluation of Raw Storability

Each of the planographic printing plate precursors was conditioned in an environment of 25° C. and 50% RH, and wrapped with an aluminum craft paper. The wrapped plate was stored in an oven kept at 60° C. for one day, and the aluminum craft paper was removed from the plate. Then, the plate was subjected to development treatment the same as that conducted in the sensitivity evaluation. The cyan density of the non-image regions on the resultant planographic printing plate was measured with a Macbeth reflection densitometer RD-918 and a red filter which the densitometer has. A value obtained by subtracting the density of the support from the measured density was evaluated as fogging density (ΔDmin). The smaller the ΔDmin is, the better the raw storability of the planographic printing plate precursor is. The results are summarized in Table 1.

(3) Evaluation of Printing Durability

Each of the planographic printing plate precursors was exposed to light with TRENDSETTER QUANTUM 800II having a water cooling-type 40 W infrared semiconductor laser and manufactured by Creo Co., Ltd. at a power of 5.5W at a rotation speed of a drum, on the external peripheral surface of which the printing plate precursor was fixed, of 200 rpm at a plate surface energy of 100 mJ/cm² so as to form an image of 1200 dpi and 1001 pi. After the exposure, the plate was developed in the same manner as in the sensitivity evaluation. TRANS INK N manufactured by Toyo Ink Mfg. serving as an ink and a damping water containing 10 mass % of isopropyl alcohol and 1 mass % of EU-3 were made to adhere to the surface of the planographic printing plate thus obtained and the printing plate was mounted on a printer, LITHRONE manufactured by Komori Corp., and was used to print the image thereof on plural sheets of paper. The number of the sheets of paper on which the image was clearly printed was used as an index for printing durability. The results are summarized in Table 1.

(4) Resistance to Adhesion Between Stacked Planographic Printing Plate Precursors

One and a half thousands planographic printing plate precursors (width of 200 mm and length of 500 mm) of the same type were stacked in an environment of 25° C. and 75% RH, and then stored in an environment of 30° C. and 75% RH for 10 days without dew condensation. Thereafter, the stacked printing plate precursors were left in an environment of 25° C. and 50% RH, and the resistance to adhesion between the stacked planographic printing plate precursors was evaluated. The evaluation criteria are shown below. The results are summarized in Table 1.

—Evaluation Criteria—

A: The stacked planographic printing plate precursors did not adhere to each other.

B: The stacked planographic printing plate precursors adhered to each other.

TABLE 1

| | | | | | | | Resistance to |
|---|---|---|---|---|---|---|---|
| | | Presence or | | | | | adhesion between |
| | | absence of | | | | | stacked |
| | | lamellar | | | | Raw | planographic |
| | Thiol | compound in | Sensitivity | Printing | | storability | printing plate |
| | compound | protective layer | (mJ/cm²) | durability | | (ΔDmin) | precursors |
| Example 1 | E-1 | Presence | 40 | 120,000 | sheets | 0.01 | A |
| Example 2 | E-2 | Presence | 40 | 120,000 | sheets | 0.01 | A |
| Example 3 | E-3 | Presence | 45 | 120,000 | sheets | 0.01 | A |
| Example 4 | E-4 | Presence | 55 | 100,000 | sheets | 0.01 | A |
| Example 5 | E-5 | Presence | 60 | 90,000 | sheets | 0.01 | A |
| Example 6 | E-1 | Absence | 35 | 120,000 | sheets | 0.01 | B |
| Example 7 | E-1 | Presence | 40 | 120,000 | sheets | 0.01 | A |
| Comparative | None | Presence | 80 | 60,000 | sheets | 0.01 | A |
| Example 1 | | | | | | | |
| Comparative | None | Absence | 60 | 100,000 | sheets | 0.01 | B |
| Example 2 | | | | | | | |

As is apparent from Table 1, the planographic printing plate precursors of Examples 1 to 7, which contain a thiol compound in the image-recording layer, have high sensitivity and printing durability and superior raw storability. Moreover, in the case of the planographic printing plate precursors of Examples 1 to 5 and 7 having a protective layer containing a lamellar inorganic compound (mica), no adhesion was found between the precursors of the same type. Therefore, these planographic printing plate precursors have also superior adhesion resistance.

In contrast, the planographic printing plate precursors of Comparative Examples 1 and 2, which contain no thiol compound in the image-recording layer, have inferior sensitivity and printing durability to the planographic printing plate precursors of the Examples 1 to 7. The planographic printing plate precursor of Comparative Example 1 containing a lamellar inorganic compound in the protective layer has good resistance to adhesion between the precursors. However, the planographic printing plate precursor of Comparative Example 2 containing no lamellar inorganic compound in the protective layer has also inferior resistance to adhesion between the precursors.

What is claimed is:

1. A planographic printing plate precursor, comprising a support and, on the support, an image-recording layer containing an infrared ray absorbent, a polymerization initiator, a polymerizable compound, and a thiol compound.

2. The planographic printing plate precursor of claim 1, flyer comprising a protective layer on the image-recording layer.

3. The planographic printing plate precursor of claim 2, wherein the protective layer contains a lamellar inorganic compound.

4. The planographic printing plate precursor of claim 1, wherein the thiol compound is represented by the following Formula (I): 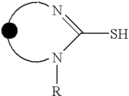
wherein in Formula (I), R represents an alkyl group that may have a substituent or an aryl group that may have a substituent, A represents an atomic group which, together with a N═C—N portion, forms a five- or six-membered carbon atom-containing heterocyclic ring and, and A may have a substituent.

5. The planographic printing plate precursor of claim 4, wherein the thiol compound is a compound represented by the following Formulae (II) or (III): 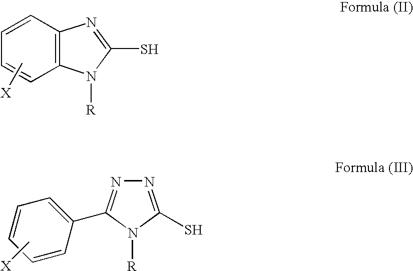
wherein in Formulae (II) and (III), R represents an alkyl group that may have a substituent or an aryl group that may have a substituent; and X represents a halogen atom, an alkoxyl group, an alkyl group that may have a substituent, or an aryl group that may have a substituent.

6. The planographic printing plate precursor of claim 1, wherein the thiol compound is at least one of the following compounds.

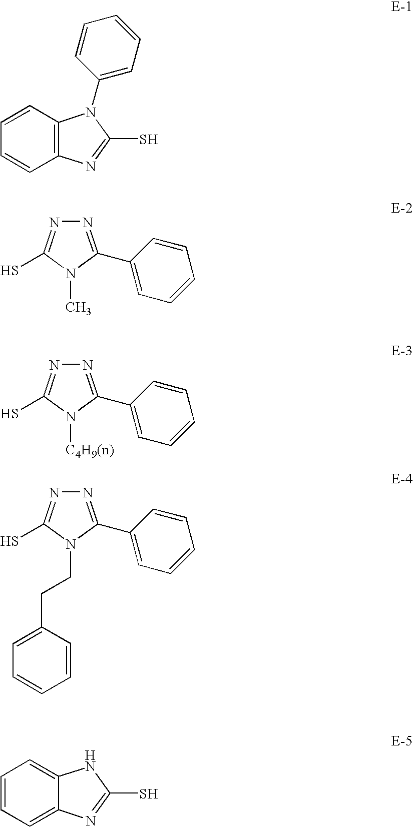

7. The planographic printing plate precursor of claim 1, wherein the image-recording layer further contains a binder polymer.

8. The planographic printing plate precursor of claim 7, wherein the binder polymer has a side chain containing a cross-linkable group.

9. The planographic printing plate precursor of claim 8, wherein the crosslinkable group is an ethylenically unsaturated bond group.

10. The planographic printing plate precursor of claim 9, wherein the ethylenically unsaturated bond group is a group represented by any one of the following Formulae (A) to (C): 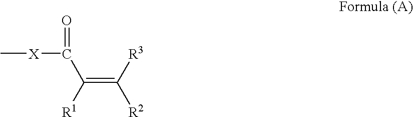
wherein in Formula (A), R¹ to R³ independently represent a hydrogen atom or a monovalent substituent composed of at least one non-metal atom; X represents an oxygen or a sulfur atom, or —N(R¹²)—; and R¹² represents a hydrogen atom or a monovalent organic group; 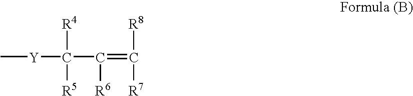
wherein in Formula (B), R⁴ to R⁸ independently represent a hydrogen atom or a monovalent substituent group composed of at least one non-metal atom; Y represents an oxygen or a sulfur atom, or —N (R¹²)—; and R¹² represents a hydrogen atom or a monovalent organic group; and 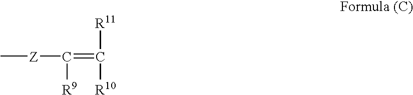
wherein in Formula (C), R⁹ to R¹¹ independently represent a hydrogen atom or a monovalent substituent group composed of at least one non-metal atom; Z represents an oxygen or a sulfur atom, or —N (R¹³)—; and R¹³ represents an alkyl group that may have a substituent.
